(19) United States
(12) Patent Application Publication
(10) Pub. No.: US 2026/0281769 A1
(43) Pub. Date: Sep. 17, 2026

(54) METHODS OF CHANNEL MEASUREMENT FOR TRS BASED TDCP REPORTING

(71) Applicant: Telefonaktiebolaget LM Ericsson (publ), Stockholm (SE)

(72) Inventors: Siva Muruganathan, Stittsville (CA); Per Ernström, Stockholm (SE); Jianwei Zhang, Solna (SE); Shiwei Gao, Nepean (CA); Venkatarao Gonuguntla, Sundbyberg (SE)

(21) Appl. No.: 19/113,604

(22) PCT Filed: Sep. 22, 2023
(86) PCT No.: PCT/IB2023/059411

§ 371 Date: Mar. 20, 2025

Related U.S. Application Data
(60) Provisional application No. 63/409,144, filed on Sep. 22, 2022.

(51) Int. Cl. H04W 24/10; H04B 7/06; H04W 72/0446; H04W 76/28

(52) U.S. Cl. CPC H04W 24/10; H04B 7/0626; H04W 72/0446; H04W 76/28

(57) ABSTRACT

Systems and methods of channel measurement for Tracking Reference Signal (TRS) based Time Domain Channel Properties (TDCP) reporting are provided. In some embodiments, the method includes receiving a reporting configuration containing a TDCP reporting quantity to be reported by the UE for TDCP reporting; receiving a reference signal configuration containing one or more TRS samples; receiving signaling indicating measurement windows; receiving signaling restricting the number of TRS samples to be considered; computing the TDCP reporting quantity to be reported only using the TRS samples in the indicated measurement windows; receiving a DCI triggering an aperiodic TDCP report; reporting the TDCP reporting quantity computed/updated. In this way, the UE measurement burden related to measuring TRSs for deriving TDCP reporting quantities can be reduced. The solutions are particularly valuable when periodic TRSs are configured and when the UE is aperiodically triggered for a TDCP report.

### RELATED APPLICATIONS

This application claims the benefit of provisional patent application Ser. No. 63/409,144, filed Sep. 22, 2022, the disclosure of which is hereby incorporated herein by reference in its entirety.

### TECHNICAL FIELD

The present disclosure relates generally to Time Domain Channel Properties (TDCP) reporting.

### BACKGROUND

### MU-MIMO

With multi-user MIMO (MU-MIMO), two or more users in the same cell are co-scheduled on the same time-frequency resource(s). That is, two or more independent data streams are transmitted to different UEs at the same time, and the spatial domain can typically be used to separate the respective streams. By transmitting several streams simultaneously, the capacity of the system can be increased. This, however, comes at the cost of reducing the SINR per stream, as the power must be shared between streams and the streams will cause interference to each-other.

### Channel State Information Reference Signals (CSI-RS)

For CSI measurement and feedback, CSI-RS are defined. A CSI-RS is transmitted on each antenna port and is used by a UE to measure downlink channel between each of the transmit antenna ports and each of its receive antenna ports. The transmit antenna ports are also referred to as CSI-RS ports. The supported number of antenna ports in NR are {1,2,4,8,12,16,24,32}. By measuring the received CSI-RS, a UE can estimate the channel that the CSI-RS is traversing, including the radio propagation channel and antenna gains. The CSI-RS for the above purpose is also referred to as Non-Zero Power (NZP) CSI-RS.

CSI-RS can be configured to be transmitted in certain REs in a slot and certain slots. FIG. 1 shows an example of CSI-RS REs for 12 antenna ports, where 1 RE per RB per port is shown.

In addition, interference measurement resource (IMR) is also defined in NR for a UE to measure interference. An IMR resource contains 4 REs, either 4 adjacent REs in frequency in the same OFDM symbol or 2 by 2 adjacent REs in both time and frequency in a slot. By measuring both the channel based on NZP CSI-RS and the interference based on an IMR, a UE can estimate the effective channel and noise plus interference to determine the CSI, i.e., rank, precoding matrix, and the channel quality.

Furthermore, a UE in NR may be configured to measure interference based on one or multiple NZP CSI-RS resource.

### TRS

Due to oscillator imperfections, transmission and reception may not be synchronized in time and/or frequency, which can cause inter- and intra-symbol interference. In NR, Tracking Reference Signal (TRS) was introduced that can be used by the UE for fine time/frequency synchronization.

In NR 3GPP specifications, TRS can be configured when CSI report setting is not configured or when the higher layer parameter ‘reportQuantity’ in the CSI-ReportConfig information element (IE), associated with all the report settings linked with the CSI-RS resource set containing the TRS(s) is set to ‘none’. This means that CSI reporting based on measurements on TRS is not supported in NR.

TRS is configured via ‘trs-Info’ in the NZP-CSI-RS-ResourceSet IE of 3GPP TS 38.331 which is associated with a CSI-RS resource set, for which the UE can assume that the antenna port with the same port index of the configured NZP CSI-RS resources in the said resource set is the same. From 3GPP specifications perspective TRS is specified as a special kind of NZP CSI-RS where the corresponding NZP CSI-RS resource set containing the TRS(s) has a higher layer parameter ‘trs-info’ set to true.

TRS is not really a CSI-RS, rather it is a resource set consisting of multiple periodic NZP CSI-RS. More specifically, a TRS consists of four one-port, density-3 CSI-RSs located within two consecutive slots. The CSI-RS within the said resource set, can be configured with a periodicity of 10, 20, 40, or 80 ms. Note that the exact set of REs used for the TRS CSI-RS may vary. There is always a four-symbol time-domain separation between the two CSI-RS within a slot. FIG. 2 shows an example of a TRS burst of two TRS symbols in two adjacent slots.

NR also supports aperiodic TRS.

For LTE, the cell-specific reference signal (CRS) served the same purpose as the TRS as LTE CRS can be used for synchronization, but it can also be used for CSI reporting, which is not supported for TRS in NR. However, compared to the LTE CRS, the TRS implies much less overhead, only having one antenna port and only being present in two slots every TRS period. FIG. 3 illustrates configurability of TRS symbol positions and TRS burst periodicity.

### CSI Framework in NR

In NR, a UE can be configured with multiple CSI reporting settings and multiple CSI-RS resource settings. Each resource setting can contain multiple resource sets, and each resource set can contain up to 8 CSI-RS resources. For each CSI reporting setting, a UE feeds back a CSI report.

Each CSI reporting setting contains at least the following information:
A CSI-RS resource set for channel measurement
An IMR resource set for interference measurement
Optionally, a CSI-RS resource set for interference measurement
Time-domain behavior, i.e., periodic, semi-persistent, or aperiodic reporting
Frequency granularity, i.e., wideband or subband
CSI parameters to be reported such as RI, PMI, CQI, and CSI-RS resource indicator (CRI) in case of multiple CSI-RS resources in a resource set
Codebook types, i.e. Type I or II, and codebook subset restriction
Measurement restriction
Subband size. One out of two possible subband sizes is indicated, the value range depends on the bandwidth of the BWP. One CQI/PMI (if configured for subband reporting) is fed back per subband).

### Type 1 and Type 2 Codebooks in NR

Type 1 codebook (CB) is typically used by a UE to report CSI for single user MIMO (SU-MIMO) scheduling in NR. While type 2 CB is typically for more accurate CSI feedback for multi-user MIMO (MU-MIMO) scheduling.

For both type 1 and type 2 CBs, for each rank, a precoding matrix W is defined in the form of

$$W = {W}_{1} {W}_{2}$$

### Where

$${W}_{1} = [ \begin{matrix}{d}_{1} & {d}_{2} & … & {d}_{L} & 0 & 0 & … & 0 \\ 0 & 0 & … & 0 & {d}_{1} & {d}_{2} & … & {d}_{L}\end{matrix} ]$$

is a 2N×2L matrix and contains information of L selected DFT beams {dᵢ, i=1, . . . , L}, where dᵢ is a N×1 DFT vector and N is the number of CSI-RS ports per polarization; while W₂ is a 2L×ν matrix and contains the co-phasing coefficients between the selected beams and also between antenna ports with two different polarizations, where ν is the number of layers or rank. W₁ is the same for the whole CSI bandwidth while W₂ can be for the whole bandwidth or per subband.

In case of type 1 CB, the precoding vector for each MIMO layer is associated with a single DFT beam. While for type 2 CB, the precoding vector for each layer is a linear combination of multiple DFT beams.

### Enhanced Type 2 Codebook in NR

In NR Rel-16, type 2 CB is enhanced by applying a frequency domain (FD) DFT basis across all subbands to reduced CSI feedback overhead and/or improve CSI accuracy. Instead of reporting W₂ for each subband, linear combinations of DFT basis vectors are used to jointly represent W₂ across the whole CSI bandwidth. For each layer, a precoding matrix W across all subbands is in the form of:

$$W = {W}_{1} {\tilde{W}}_{2} {W}_{f}^{H}$$

Where W_{ƒ}=[ƒₗ, . . . , ƒ_{M}] is a matrix containing M selected DFT basis vectors {ƒ₁, . . . , ƒ_{M}}, \tilde{W}₂ is 2L×M matrix containing the coefficients for each selected DFT beam and each selected FD basis vector.

### QCL and TCI States

Several signals can be transmitted from different antenna ports of a same base station. These signals can have the same large-scale properties such as Doppler shift/spread, average delay spread, or average delay. These antenna ports are then said to be quasi co-located (QCL).

If the UE knows that two antenna ports are QCL with respect to a certain parameter (e.g., Doppler spread), the UE can estimate that parameter based on one of the antenna ports and apply that estimate for receiving signal on the other antenna port. Typically, the first antenna port is represented by a measurement reference signal such as TRS or SSB (known as source RS) and the second antenna port is a demodulation reference signal (DMRS) (known as target RS).

For instance, if antenna ports A and B are QCL with respect to average delay, the UE can estimate the average delay from the signal received from antenna port A and assume that the signal received from antenna port B has the same average delay. This is useful for demodulation since the UE can know beforehand the properties of the channel, which for instance helps the UE in selecting an appropriate channel estimation filter.

Information about what assumptions can be made regarding QCL is signaled to the UE from the network. In NR, four types of QCL relations between a transmitted source RS and transmitted target RS were defined:

Type A: {Doppler shift, Doppler spread, average delay, delay spread}
Type B: {Doppler shift, Doppler spread}
Type C: {average delay, Doppler shift}
Type D: {Spatial Rx parameter}

### Aperiodic CSI-RS/IM and CSI Reporting

For both aperiodic CSI-RS/IM resources and aperiodic CSI reports, the triggering is done jointly by transmitting a DCI Format 0_1 from the gNB to the UE, using the downlink control channel, PDCCH. This is the DCI format which schedules PUSCH transmission where the aperiodic CSI report is to be carried. The DCI Format 0_1 contains a CSI request field which can be configured to be between 0 and 6 bits wide using higher layer configuration (i.e., RRC) from gNB to UE.

The CSI request field can thus contain at most S_{c}=2⁶=64 codepoints. If this field is set to all zeros, no CSI is requested, and the DCI 0_1 only schedules a regular PUSCH transmission containing UL data. A non-zero codepoint on the other hand points to a so-called aperiodic trigger state configured by RRC from gNB to UE. An aperiodic trigger state is defined as a list of up to at most 16 aperiodic CSI Report Settings, each identified by a CSI Report Setting ID, (but typically, a much lower number of report settings is used) for which the UE simultaneously should calculate CSI for and include in the scheduled PUSCH transmission.

If a CSI Report Setting is linked with periodic/semi-persistent Resource Setting(s), no further information is needed since there is only one Resource Set included in the Resource Setting for channel/interference measurement in this case.

However, if the CSI Report Setting is linked with an aperiodic Resource Setting (which can comprise multiple Resource Sets), which CSI-RS/IM Resource set should be used for measurement must be indicated in DCI 0_1. Hence, this allows the gNB, for a given CSI Report Setting, to dynamically switch which CSI-RS/IM resource shall be used for measurement each time the aperiodic report is triggered by DCI 0_1, by configuring by RRC and indicating by DCI 0_1 different aperiodic trigger states. This means that the aperiodic NZP CSI-RS Resource Set for channel measurement, the aperiodic CSI-IM Resource Set for interference measurement (if that is used) and the aperiodic NZP CSI-RS Resource Set for interference measurement (if used) to use for a given CSI Report Setting is also included in the aperiodic trigger state definition.

For aperiodic NZP CSI-RS, the QCL source to use (i.e., the TCI state) is also configured in the aperiodic trigger state, which enables the gNB to dynamically switch UE Rx beam assumptions for the reception of the NZP CSI-RS.

The aperiodic trigger state definition is illustrated in FIG. 4.

It is possible to configure up to 128 aperiodic trigger states via RRC. However, the number of codepoints of the CSI request bitfield in DCI 01 only ranges between 0-63. Therefore, it is possible that more trigger states are configured in RRC than can be indicated with the DCI field. When this is the case, i.e., M aperiodic trigger states are configured in RRC but the CSI request bitfield (with bitwidth N_{TS}=0, . . . ,6) only contains S_{c}=2^{N}^{_{Ts}}−1<M non-zero codepoints, an intermediary sub-selection, or mapping, between the S_{c} codepoints and the M RRC configured trigger states needs to be performed. This sub-selection is performed by transmitting a MAC CE sub-selection command.

The aperiodic CSI-RS/IM is essentially a one-shot measurement which is only present for a single time instance and is only used to determine CSI for a single aperiodic report. The position, in time, of the aperiodic CSI-RS/IM is defined as a slot offset relative to the slot where the DCI containing the trigger was received. The slot offset is defined on a CSI-RS resource set level and the offset allows the UE to use some time to complete the CSI measurements and calculation of the reports and prepare the uplink transmission of the reports. For aperiodic CSI-IM, there is no explicit slot offset defined but rather it is assumed that the CSI-IM and CSI-RS is present in the same slot to enable efficient CSI processing at the UE.

### CPU Processing Unit

In NR, the UE has a capability of 5-30 CSI processing units (CPUs), which can be used to calculate any types of CSI report. A periodic or semi-persistent CSI report (excluding an initial semi-persistent CSI report on PUSCH after the PDCCH triggering the report) occupies CPU(s) from the first symbol of the earliest one of each CSI-RS/CSI-IM/SSB resource for channel or interference measurement, respective latest CSI-RS/CSI-IM/SSB occasion no later than the corresponding CSI reference resource, until the last symbol of the PUSCH/PUCCH carrying the report. An aperiodic CSI report occupies a CPU(s) from the first symbol after the PDCCH triggering the CSI report until the last symbol of the PUSCH carrying the report. If a UE is triggered/configured to report CSI but has no available CPUs, the CSI is not required to be updated.

### CSI Processing Criteria and UE Capability for CSI Reporting

In LTE, the concept of a CSI process was introduced in Rel-11 for the purpose of supporting CoMP, i.e., feedback of several different CSI reports corresponding to multiple transmission points. Each CSI process was associated with a specific kind of reporting configuration (i.e., CSI content and measurement resource) and the UE is assumed to always be able to provide CSI for all its supported CSI processes on a carrier. Thus, for LTE, the CSI computation capability reported by the UE is the support of a number X of reporting configurations. However, such a tight coupling between CSI capability and configured reporting configurations X was not suitable for the more flexible NR CSI framework.

Instead, the NR CSI computation capability separates the number of supported configured CSI Report Settings and the number of supported simultaneous CSI calculations. That is, the concept of CSI process is generalized in NR with the introduction of the CSI processing Unit (CPU), where the number of CPUs is equal to the number of simultaneous CSI calculations supported by the UE. The CPU can be seen as a generic CSI calculation engine which can process any kind of CSI report. That is, the CPUs are a pool of computational resources. For instance, the UE can indicate support for four configured CSI Report Settings but only support a single simultaneous CSI calculation (i.e., supporting a single CPU). This means that the gNB can trigger any of the 4 different CSI reports but has to multiplex the different CSI reports calculations in time. The different configured CSI report settings may for instance correspond to different codebook configurations (i.e. Type I and Type II codebooks), different types of beam reports (e.g., P2 and P3), different CSI hypotheses used in CoMP operation or CSI reports corresponding to different carriers.

The framework works as follows. When calculation of a CSI report is about to proceed, i.e., either when the UE gets triggered with an aperiodic CSI report or when the computation starts for a periodic or semi-persistent CSI report, the CSI report is allocated to one or multiple available CPU(s). If there are not enough CPUs available due to that the UE is already have ongoing processing of other CSI reports, an additional CSI reporting allocated by the gNB does not have to be calculated by the UE and the UE can instead report stale CSI to the gNB, such as a previously calculated CSI report stored in memory or simply padding the CSI report with dummy bits. The CSI report is not dropped in this case, but some content is always transmitted in order to not change the rate matching procedures for the PUSCH or PUCCH transmission, which could be error prone. In practice, the gNB should strive for only triggering/configuring as many CSI reports as the UE is capable of handling so that stale CSI does not need to be reported by the UE.

Each CSI report that is committed for calculation by the UE thus occupies a number O_{CPU} CPUs from a starting allocation time until the last symbol of the physical channel (i.e., PUCCH or PUSCH) carrying the CSI report to the gNB has finished transmitting from the UE, whereby the

$${O}_{CPU}^{( n )}$$

CPUs are then released. For aperiodic CSI report, the starting allocation time of the CPU(s) is the last symbol of the PDCCH containing the DCI which triggered the report, while for periodic and semi-persistent CSI reports, the CPUs are allocated from the time of the occurrence of the latest CSI-RS/IM resource used to calculate the particular report. That is, for periodic/semi-persistent reports, the UE can be assumed to start calculation of the CSI report as soon as it has received the latest occurrence of the measurement resource.

The number of CPUs O_{CPU} occupied by a certain CSI report depends on the content of the report. For non-beam related CSI reports (i.e., when the reportQuantity is not equal to ‘cri-RSRP’, ‘ssb-Index-RSRP’ or ‘none’), the CSI report occupies as many CPUs as the number of CSI-RS resources in the CSI-RS resource set for channel measurement. This is because a UE may, in the worst case, need to calculate a complete CSI report for each CSI-RS resource in parallel in order to determine which CSI-RS resource is optimal and shall be selected with the CRI (of course, a UE implementation may use simpler approaches to determine the CRI, such as comparing the signal strength of the resources). For beam-related reports, on the other hand, the required computations are not as complex and only a single CPU (Ocₚu=1) is occupied, even if multiple CSI-RS resources are included in the CSI-RS resource set for channel measurement. The gNB also has the possibility to trigger an aperiodic TRS using the triggering mechanisms of the CSI framework, however this does not occupy any CPUs and it is instead assumed that the UE has dedicated resources for TRS processing.

If multiple CSI reports are about to be allocated to use CPUs on a given OFDM symbol, they are ordered according to a set of priority rules. That is, if N CSI reports start occupying their respective CPUs on the same OFDM symbol on which N_{CPU}−L CPUs are unoccupied, where each CSI report n=0, . . . , N−1 corresponds to

$${O}_{CPU}^{( n )} ,$$

the UE is not required to update the N−M requested CSI reports with lowest priority where 0≤M≤N is the largest value such that

$${\sum }_{i = 0}^{M - 1} {O}_{CPU}^{( n )} \leq {N}_{CPU} - L holds .$$

The concept of CPU occupation is illustrated in FIG. 5, where the UE is assumed to have two CPUs available, and where CPU #1 gets allocated by the periodic (P) CSI report in slot 0, which is the slot of the latest NZP CSI-RS occurrence (no later than the CSI reference resource) used by the P CSI report. While the P CSI report is calculated, the UE gets triggered with two consecutive aperiodic CSI reports, #1 and #2, which are allocated to CPU #2. After both CPUs are released, the UE gets triggered with two simultaneous aperiodic CSI reports, #3 and #4, which respectively occupies CPU #1 and CPU #2. Before these CSI reports have finished calculating, the UE gets triggered with another aperiodic CSI report, #5. However, since there are no more CPUs available, that CSI report is not computed by the UE and instead stale or dummy CSI is reported for aperiodic CSI report #5.

### Channel Correlation, Doppler Spectrum, and Jakes Model

The wireless channel h(t) between a gNB and a UE can change over time as the UE moves. This is typically because the signals received at the UE comprise many paths of radio waves reflected from objects (such as trees and buildings) surround the UE, where each path has a different angle of arrival (AOA) at the UE and thus a different Doppler frequency as UE moves. When the AOAs of the paths are uniformly distributed over [−π, π] in the azimuth direction, it is well known that the Doppler power spectrum for the channel h(t) can be modeled using the Jakes model (i.e., in two dimensions) as follows:

$$S ( f ) = \{ \begin{matrix}\frac{1}{π \cdot {f}_{m ax}} \cdot \frac{1}{\sqrt{1 - {( \frac{f}{{f}_{ma x}} )}^{2}}} & ( \vert f \vert \leq {f}_{m ax} ) \\ 0 & ( \vert f \vert > {f}_{m ax} )\end{matrix}$$

The autocorrelation of the channel is defined as Rₕₕ(τ)=E[h(t)h*(t+T)]. The normalized autocorrelation Rₕₕ(τ)/Rₕₕ(0)=J₀(2π·τƒₘₐₓ), which is the inverse Fourier transform of S(ƒ), where J₀(·) is the zeroth order Bessel function of the first kind, E[·] denotes expectation.

FIG. 6 shows the zeroth order Bessel function of the first kind (the y-axis shows the autocorrelation, and the x axis shows 2π·τ·ƒₘₐₓ). It can be seen that it is monotonic only for when 2π·τ·ƒₘₐₓ<3.8317, and within that range and for a given τ, there is a one-to-one mapping between a correlation value and an ƒₘₐₓ.

### Rel-18 Specification of TRS Based TDCP Reporting

In RAN1 #109e meeting, the following agreement was reached:

### Agreement

The work scope of TRS-based TDCP reporting focuses on the following use cases for evaluation purposes:
Targeting medium and high UE speed, e.g., 10-120 km/h as well as HST speed
Aiding gNB to determine
   CSI reporting configuration and CSI-RS resource configuration parameters,
   Precoding scheme, using one of the CSI feedback-based precoding schemes or an UL-SRS reciprocity-based precoding scheme
Aiding gNB-side CSI prediction

As agreed above, there are several use cases for the gNB to know the Time Domain Channel Properties (TDCP) based on TRS measurements. One use case for TDCP reporting is to enable the gNB to select a transmission scheme that is more robust to channel ageing when the channel varies fast. For instance, based on the TRS-based TDCP reported by the UE to the gNB, the gNB may need to decide whether the precoder for the UE should be based on CSI obtained from uplink measurements or from CSI feedback obtained from the UE. Another example is that the gNB may need to decide whether the precoder to schedule the UE should be based on Type I CSI feedback obtained from the UE or Type II CSI feedback obtained from the UE.

FIG. 7 shows mean user throughput for a particular scheme relative to the mean throughput for feedback-based SU-MIMO precoding (the baseline). In FIG. 7, relative mean user throughput versus UE speed for reciprocity- and feedback-based CSI. For the top of FIG. 7: 16 gNB antenna ports. Bottom: 32 gNB antenna ports. The throughput is calculated for a traffic load corresponding to 70% resource utilization for the baseline case at each UE speed. Results for both SU-MIMO and MU-MIMO are shown in the figure. The scenario is UMa with 500 m inter-site distance. The carrier frequency is 2 GHz and the subcarrier spacing is 15 kHz. The CSI periodicity is 20 ms for both feedback and reciprocity-based CSI. The results show that reciprocity-based precoding has better performance at 3 km/h for both SU-MIMO and MU-MIMO. However, at UE speeds around 10 km/h the feedback-based precoding has better performance. Hence, the feedback-based precoding is more robust to rapidly varying channels. A speed of 10 km/h corresponds to a channel coherence time which is longer than two slots.

FIG. 8 shows a comparison of the performance of precoding based on Type I and Type II CSI, respectively. The results show that Type II CSI gives better performance at 3 km/h but at UE speeds around 10 km/h and higher, Type I gives better performance.

These results show that it could be beneficial to select precoding scheme based on some parameter that is related to the UE speed. It should be noted that it is not the UE speed per se that is the fundamental parameter in this context. Rather, it is how fast the channel varies which depends on the UE speed but also on the angle between the UE velocity vector and the propagation paths seen from the UE. Therefore, selection of precoding scheme based on some time domain channel property such as coherence time or autocorrelation is a more suitable parameter.

UE measurement and reporting of time domain correlation based on TRS samples across different time lags is an efficient way to report TDCP based on TRS.

In order to define the time domain correlation measurement across TRS samples, let Xₗ[n], n=0,1, . . . , N−1 be the received frequency domain TRS samples after matched filtering and after removing the reference signal sequence. Index l denote the different OFDM symbols carrying the TRSs used for the correlation estimation. Note that the TRSs used for the correlation estimation may be located in the same or different slots. The starting point in time of the OFDM symbol l is given by tₗ (to be precise tₗ denotes the start of the non-CP part of the OFDM symbol). Index n denote TRS sample index (assumed to be proportional to subcarrier index).

Let Pₘ(u), m=1 . . . M, u=1,2 be the l-indices of M symbol pairs to use for the estimation of the correlation for a delay τ=t_{P}_{ₘ}₍₂₎−t_{P}_{ₘ}₍₁₎. It is assumed that the M symbol pairs are separated by the same distance in time.

In one example, a low-complexity estimate of the normalized time domain correlation for a delay τ is calculated in the frequency domain as:

$$ϕ ( τ ) = \frac{{\sum }_{m = 1}^{M} {\sum }_{n = 0}^{N - 1} {X}_{{P}_{m} ( 2 )} [ n ] \cdot {X}_{{P}_{m} ( 1 )}^{*} [ n ]}{\frac{1}{2} {\sum }_{m = 1}^{M} {\sum }_{n = 0}^{N - 1} ( {X}_{{P}_{m} ( 1 )} [ n ] \cdot {X}_{{P}_{m} ( 1 )}^{*} [ n ] + {X}_{{P}_{m} ( 2 )} [ n ] \cdot {X}_{{P}_{m} ( 2 )}^{*} [ n ] )} ,$$

In another example, the inverse DFT is calculated for each OFDM symbol l:

$${Y}_{l} [ k ] = ifft ( {X}_{l} [ n ] )$$

The estimate of the normalized correlation for time delay τ is calculated as:

$${ϕ}^{Δ t} ( t , τ ) = \frac{{\sum }_{m = 1}^{M} {\sum }_{k ∈ Γ ( m )} {Y}_{{P}_{m} ( 2 )} [ k ] \cdot {Y}_{{P}_{m} ( 1 )}^{*} [ k ]}{\frac{1}{2} {\sum }_{m = 1}^{M} {\sum }_{k ∈ Γ ( m )} ( {Y}_{{P}_{m} ( 1 )} [ k ] \cdot {Y}_{{P}_{m} ( 1 )}^{*} [ k ] + {Y}_{{P}_{m} ( 2 )} [ k ] \cdot {Y}_{{P}_{m} ( 2 )}^{*} [ k ] )} ,$$

where the sum over time samples is over sets Γ(m) defined to suppress noise, e.g., by using a noise threshold such as e.g.,

$$k ∈ Γ ( m ) ⇔ \{ \begin{matrix}\frac{\vert {Y}_{{P}_{m} ( 1 )} [ k ] \vert}{{σ}_{{P}_{m} ( 1 )}} > threshold \\ \frac{\vert {Y}_{{P}_{m} ( 2 )} [ k ] \vert}{{σ}_{{P}_{m} ( 2 )}} > threshold\end{matrix}$$

where σ_{P}_{ₘ}₍ᵢ₎ are noise estimates.

Note that at low speeds the change in the channel is small and the change in correlation at different delays within a TRS burst is quite small (note that the TRS burst is defined as in FIG. 2). Within a TRS burst, correlation can be measured for delays of 4 symbols, 10 symbol, 14 symbol, and 18 symbols as shown in FIG. 9. FIG. 9 illustrates delays τₖ for which the correlation can be estimated based on intra TRS burst measurements using the TRS signal. Note that for τ₁=4·T_{OFDM+CP} and for τ₂=T_{SLOT}=14·T_{OFDM+CP} there are two samples within the TRS burst that can be used for the measurement, while for τ₃=18·T_{OFDM+CP} and τ₄=10·T_{OFDM+CP} there is only one sample within the TRS burst that can be used for the measurement.

As the change in correlation at different delays within a TRS burst is quite small for low velocities, intra TR burst measurements are not enough to distinguish between different velocities in the low velocity region. Therefore, support for measuring and reporting correlation for time delays corresponding to multiple TRS bursts is needed.

As an alternative to reporting correlation at different delays, other reporting quantities may also be considered for TRS based TDCP reporting. The Doppler spread ƒ_{d} defined as the second moment of the Doppler power spectrum Ã(ƒ) (the Fourier transform of the autocorrelation function):

$${f}_{d} = \frac{{\int }_{- ∞}^{∞} {f}^{2} \cdot \tilde{A} ( f ) df}{{\int }_{- ∞}^{∞} \tilde{A} ( f ) df}$$

is directly related to the second derivative of the autocorrelation at zero autocorrelation lag and thus gives the form of the autocorrelation function for small autocorrelation lags.

Measurements of the second moment of the Doppler power are most likely being performed in the time-lag domain rather than in the Doppler-shift domain. In fact, it would most likely be based on measurements of the Autocorrelation for a number of autocorrelation lags. Thus, if this measure would be used, a definition based on the autocorrelation would be preferable than one based on the Doppler power spectrum. For example, Doppler spread ƒ_{d} could be defined in terms of the normalized autocorrelation function by:

$$A ( τ ) = 1 - 2 {π}^{2} {f}_{d}^{2} \cdot {τ}^{2} + σ ( {τ}^{4} )$$

There currently exist certain challenge(s).

### SUMMARY

Systems and methods of channel measurement for Tracking Reference Signal (TRS) based Time Domain Channel Properties (TDCP) reporting are provided. In some embodiments, the method includes receiving from a network a reporting configuration containing a TDCP reporting quantity to be reported by the UE for TDCP reporting; receiving from the network a reference signal configuration containing one or more TRS samples; receiving signaling from the network indicating one or more measurement windows; receiving signaling from the network restricting the number of TRS samples to be considered when computing/updating TDCP reporting quantity; computing and/or updating the TDCP reporting quantity to be reported only using the TRS samples in the indicated one or more measurement windows; computing and/or updating the TDCP reporting quantity to be reported only using indicated number of TRS samples; receiving a DCI from the network triggering an aperiodic TDCP report; reporting the TDCP reporting quantity computed/updated during the one or more measurement windows as part of the aperiodic TDCP report; and reporting the TDCP reporting quantity computed/updated only using the indicated number of TRS samples as part of the aperiodic TDCP report. In this way, the UE measurement burden related to measuring TRSs for deriving TDCP reporting quantities can be reduced. The solutions are particularly valuable when periodic TRSs are configured and when the UE is aperiodically triggered for a TDCP report. Additionally, some of the proposed autocorrelation measures are robust towards phase jumps. Some of the proposed autocorrelation measures are robust towards frequency adjustments. In some embodiments, a measurement window containing multiple measurement opportunities and allowing the UE to discard some of the measurement opportunities due to phase jumps and/or frequency adjustments, give robustness against such events.

In the present disclosure, the following aspects are proposed: signaling measurement window in which the UE can compute/update TDCP reporting quantities thus alleviating the need for UE to always compute/update TDCP reporting (thus reducing the UE measurement/computation/update burden related to TDCP reporting); mechanisms related to the order of the operations (averaging over time, averaging over frequency, taking the absolute value, normalizing) in the definition of the autocorrelation measures when autocorrelation is to be reported as the TDCP reporting quantity; aspects related to when the UE can discard some of the measurements or measurement opportunities within the measurement window; and rules on number of CPUs occupied for measurements and computation related to TDCP reporting.

In some embodiments, a method for TDCP reporting based on measurement on TRS samples, the method comprising: receiving from a network a reporting configuration containing a TDCP reporting quantity to be reported by the UE for TDCP reporting; receiving from the network a reference signal configuration containing one or more TRS samples; receiving signaling from the network indicating one or more measurement windows; UE computing or updating the TDCP reporting quantity to be reported only using the TRS samples in the indicated one or more measurement windows; receiving a DCI from the network triggering an aperiodic TDCP report; UE reporting the TDCP reporting quantity computed/updated during the one or more measurement windows as part of the aperiodic TDCP report.

In some embodiments, a method for TDCP reporting based on measurement on TRS samples, the method comprising: receiving from a network a reporting configuration containing a TDCP reporting quantity to be reported by the UE for TDCP reporting; receiving from the network a reference signal configuration containing one or more TRS samples; receiving signaling from the network restricting the number of TRS samples to be considered when computing/updating TDCP reporting quantity; UE computing or updating the TDCP reporting quantity to be reported only using indicated number of TRS samples; receiving a DCI from the network triggering an aperiodic TDCP report; UE reporting the TDCP reporting quantity computed/updated only using the indicated number of TRS samples as part of the aperiodic TDCP report.

In some embodiments, the order of the operations (averaging over time, averaging over frequency, taking the absolute value, normalizing) in the definition of the autocorrelation measures.

In some embodiments, aspects related to when the UE can discard some of the measurements or measurement opportunities within the measurement window.

In some embodiments, rules on number of CPUs occupied for measurements and computation related to TDCP reporting.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows an example of Channel State Information Reference Signals (CSI-RS) Resource Elements (Res) for 12 antenna ports, where 1 RE per Resource Block (RB) per port is shown;

FIG. 2 shows an example of a Tracking Reference Signal (TRS) burst of two TRS symbols in two adjacent slots;

FIG. 3 illustrates configurability of TRS symbol positions and TRS burst periodicity;

FIG. 4 illustrates the aperiodic trigger state definition;

FIG. 5 illustrates the concept of Central Processing Unit (CPU) occupation, where the UE is assumed to have two CPUs available;

FIG. 6 shows the zeroth order Bessel function of the first kind (the y-axis shows the autocorrelation, and the x axis shows 2π·τ·ƒₘₐₓ);

FIG. 7 shows mean user throughput for a particular scheme relative to the mean throughput for feedback-based Single User-Multiple Input Multiple Output (SU-MIMO) precoding (the baseline);

FIG. 8 shows a comparison of the performance of precoding based on Type I and Type II CSI, respectively;

FIG. 9 illustrates delays τₖ for which the correlation can be estimated based on intra TRS burst measurements using the TRS signal;

FIG. 10 illustrates an example showing a periodic TRS-Measurement Time Configuration (TRS-MTC), according to some embodiments of the present disclosure;

FIG. 11 illustrates an example showing aperiodic triggering of Time Domain Channel Properties (TDCP) report where the TDCP quantities to be reported are measured using a periodic TRS-MTC, according to some embodiments of the present disclosure;

FIG. 12 illustrates an example showing aperiodically triggered TRS-MTC, according to some embodiments of the present disclosure;

FIG. 13 illustrates a method performed by a User Equipment (UE) for TDCP reporting based on measurement on TRS samples, according to some embodiments of the present disclosure;

FIG. 14 shows an example of a communication system in accordance with some embodiments;

FIG. 15 shows a UE in accordance with some embodiments;

FIG. 16 shows a network node in accordance with some embodiments;

FIG. 17 is a block diagram of a host, which may be an embodiment of the host of FIG. 14, in accordance with various aspects described herein;

FIG. 18 is a block diagram illustrating a virtualization environment in which functions implemented by some embodiments may be virtualized; and

FIG. 19 shows a communication diagram of a host communicating via a network node with a UE over a partially wireless connection in accordance with some embodiments.

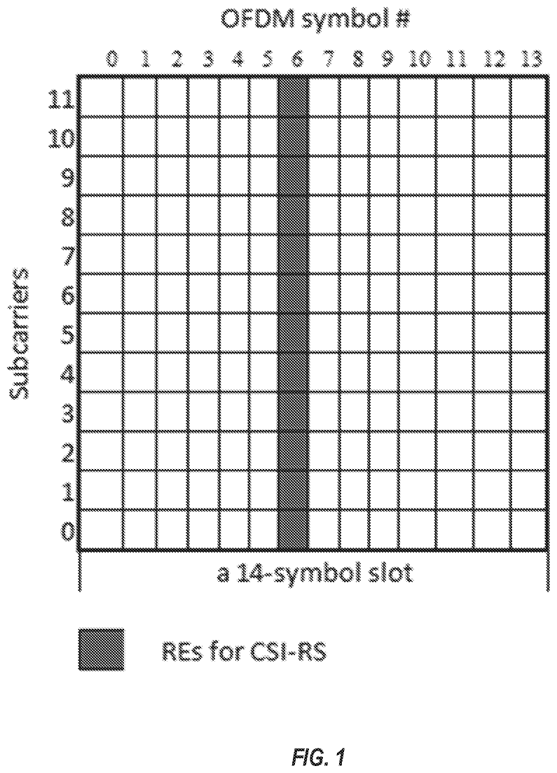

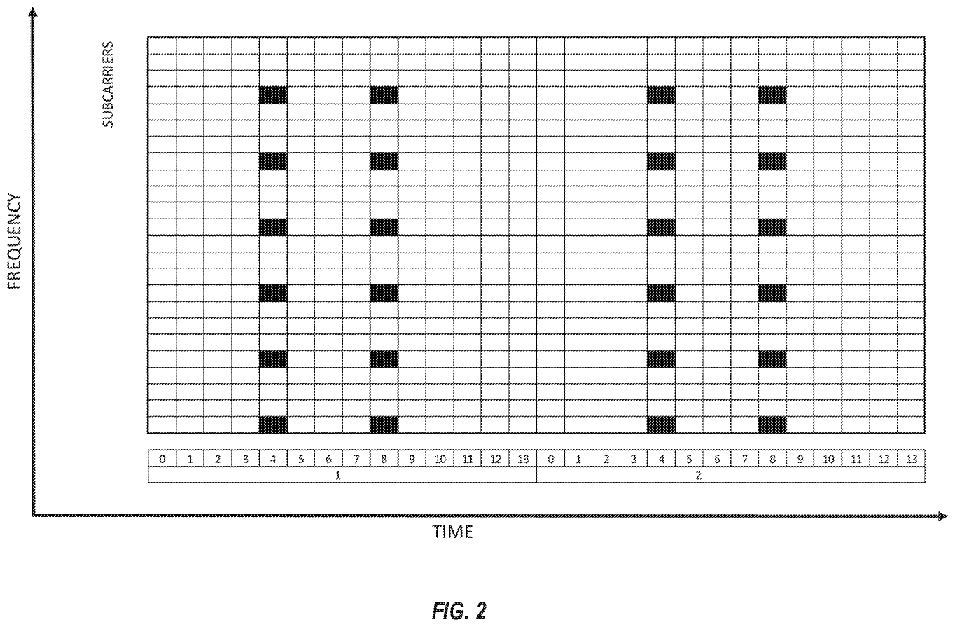

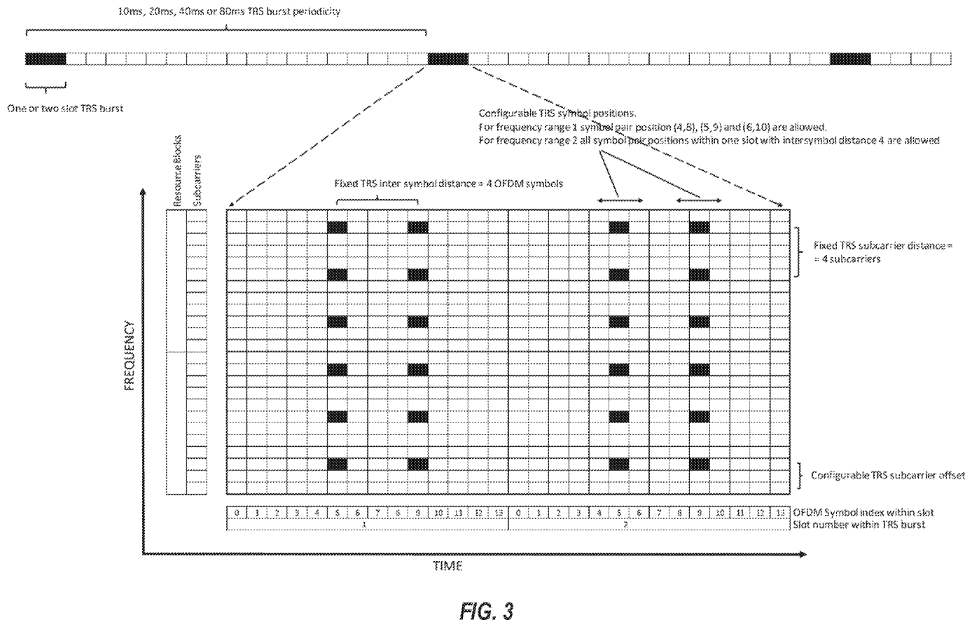

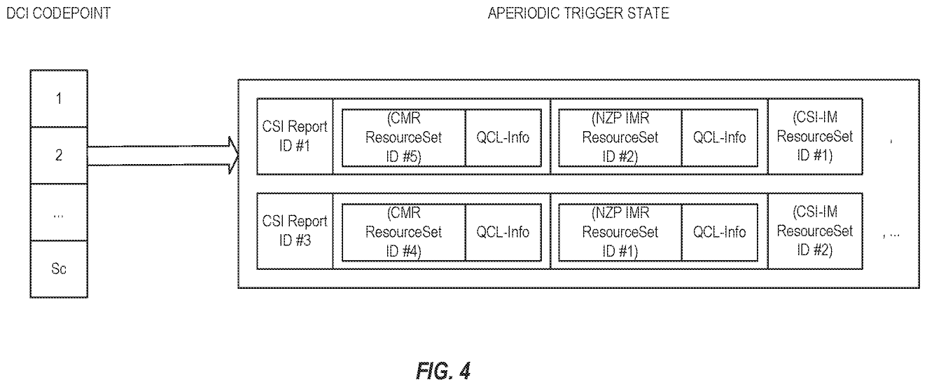

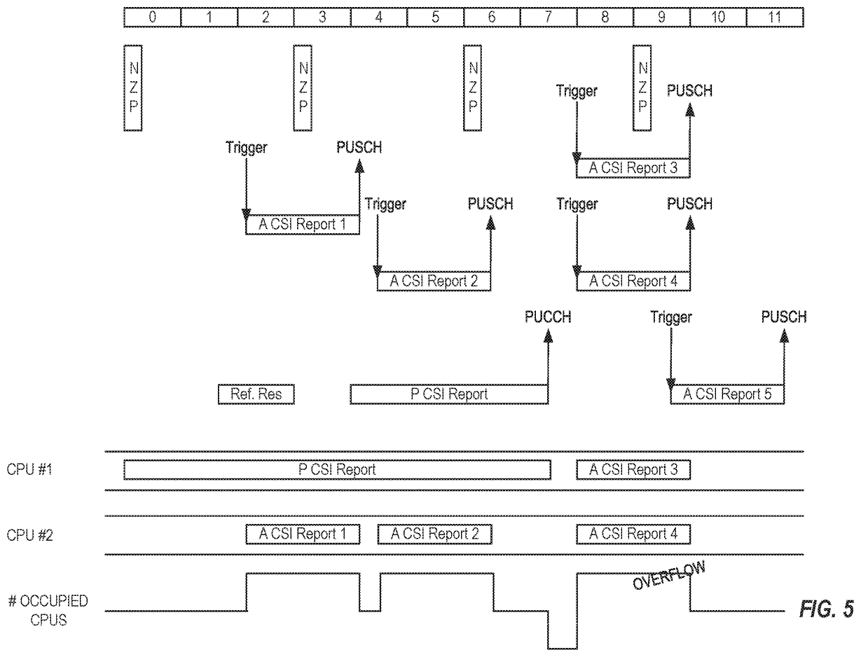

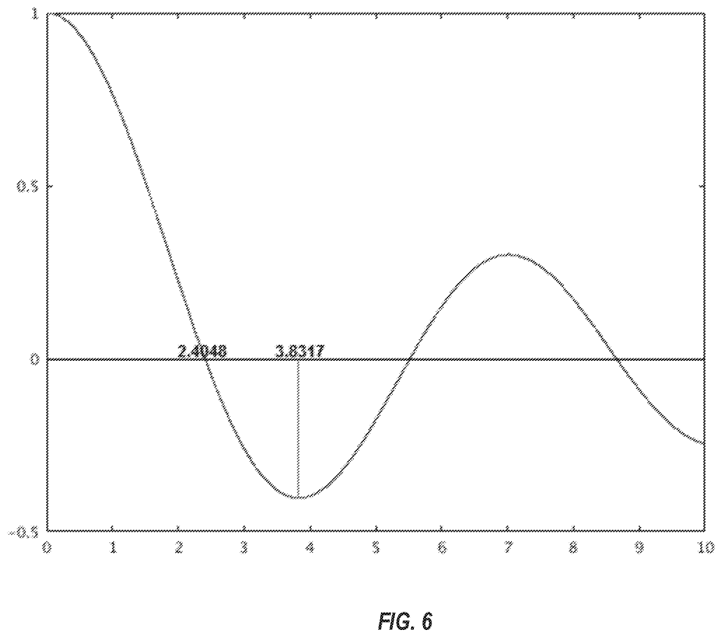

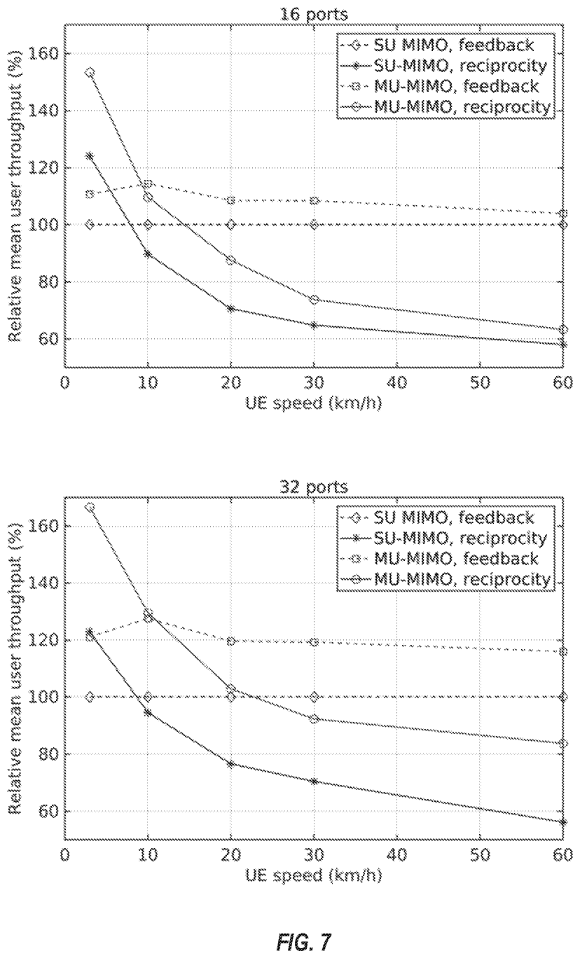

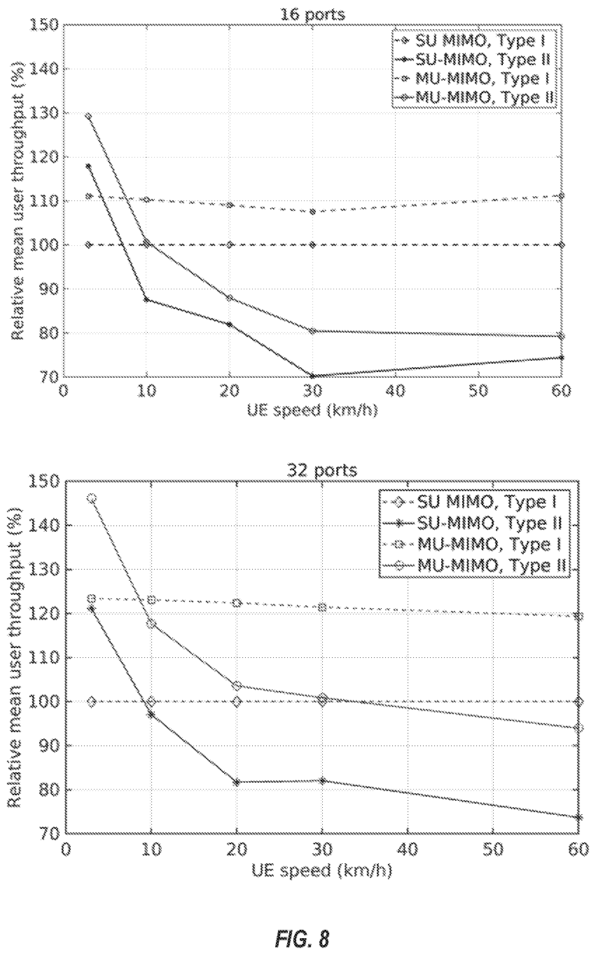

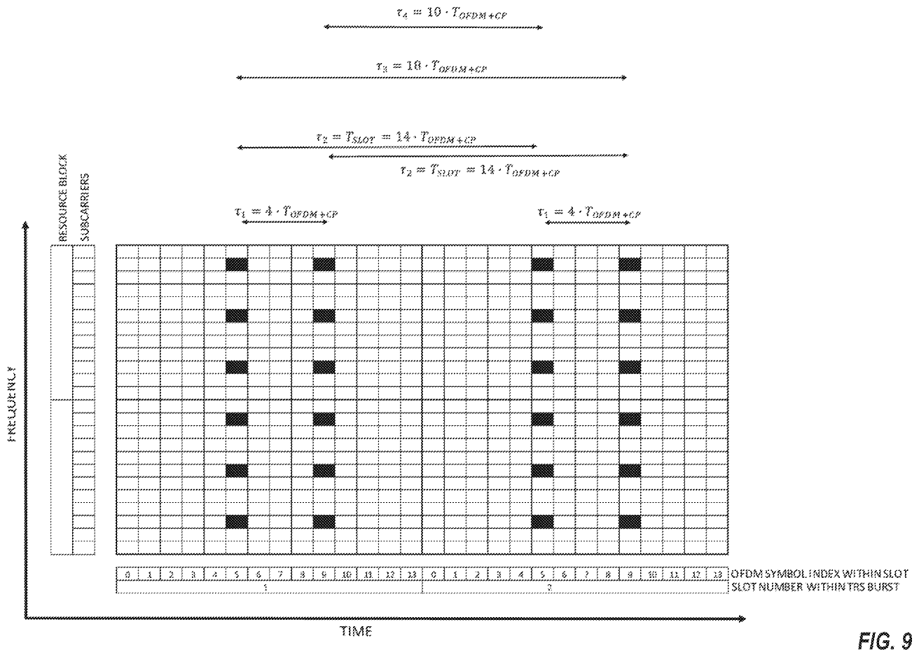

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

As discussed above, for Tracking Reference Signal (TRS) based Time Domain Channel Properties (TDCP) reporting, the TDCP quantity to be reported (e.g., autocorrelation values at different lags or Doppler spread ƒ_{d}) may need measurements of TRSs transmitted in different lags. When a TDCP report is aperiodically triggered via a DCI, the UE may need to be ready with measured TDCP quantities to be reported in response to the aperiodic trigger. However, when periodic TRSs are configured, the UE may need to always measure the TRSs at every periodicity and compute/update the TDCP quantity since the UE does not know beforehand when the aperiodic trigger for a TDCP report will be received. This will increase the UE measurement burden. Hence, it is an open problem on how to alleviate the measurement burden when UE is to support aperiodically triggered TDCP reports.

Another problem is that phase jumps and RX-frequency adjustments may occur in the UE while TDCP measurements are being performed, which may impact the TDCP measurements.

Certain aspects of the disclosure and their embodiments may provide solutions to these or other challenges.

Systems and methods of channel measurement for TRS based TDCP reporting are provided. In some embodiments, the method includes receiving from a network a reporting configuration containing a TDCP reporting quantity to be reported by the UE for TDCP reporting; receiving from the network a reference signal configuration containing one or more TRS samples; receiving signaling from the network indicating one or more measurement windows; receiving signaling from the network restricting the number of TRS samples to be considered when computing/updating TDCP reporting quantity; computing and/or updating the TDCP reporting quantity to be reported only using the TRS samples in the indicated one or more measurement windows; computing and/or updating the TDCP reporting quantity to be reported only using indicated number of TRS samples; receiving a DCI from the network triggering an aperiodic TDCP report; reporting the TDCP reporting quantity computed/updated during the one or more measurement windows as part of the aperiodic TDCP report; and reporting the TDCP reporting quantity computed/updated only using the indicated number of TRS samples as part of the aperiodic TDCP report. In this way, the UE measurement burden related to measuring TRSs for deriving TDCP reporting quantities can be reduced. The solutions are particularly valuable when periodic TRSs are configured and when the UE is aperiodically triggered for a TDCP report. Additionally, some of the proposed autocorrelation measures are robust towards phase jumps. Some of the proposed autocorrelation measures are robust towards frequency adjustments. In some embodiments, a measurement window containing multiple measurement opportunities and allowing the UE to discard some of the measurement opportunities due to phase jumps and/or frequency adjustments, give robustness against such events.

In one embodiment, a UE may be configured with TRS Measurement Time Configuration (TRS-MTC) where the UE is only required to compute/update the TDCP quantities using the TRS samples and/or TRS bursts within the configured measurement time. The TRS-MTC may be thought of as a measurement window where the UE computes/updates the TDCP quantities only using the TRS samples and/or TRS bursts within each measurement window. Note that the TRS-MTC does not put any restrictions on when the UE can use the TRS samples for fine time/frequency synchronization. That is, UE will be allowed to use any of the TRS samples and/or TRS bursts, regardless of whether they are inside or outside the TRS-MTC, to perform fine time/frequency synchronization. However, the UE does not compute/update TDCP quantities using the TRS samples and/or TRS bursts that are outside the TRS-MTC.

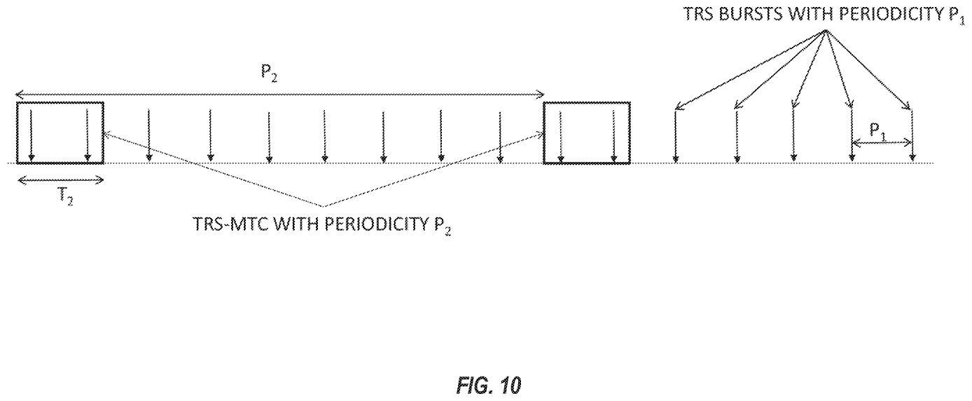

An example showing a periodic TRS-MTC is depicted in FIG. 10. In this figure, the vertical arrows represent periodic TRS bursts with a periodicity of P1 (i.e., two TRS bursts are separated by P1 where P1 may be defined in terms of slots or symbols). The TRS measurement window or TRS-MTC in this example is configured with a periodicity P2 (i.e., gap between two TRS measurement windows is given by P2 where P2 may be defined in terms of slots or symbols). Then, the UE may compute/update the TDCP quantities using TRS samples and/or TRS bursts within each of the periodic TRS measurement windows. For example, when autocorrelation with a given lag is used as the TDCP reporting quantity, the UE may compute or update the autocorrelation between two TRS samples belonging to two TRS bursts within the TRS measurement window (shown by two vertical arrows within each TRS measurement window or TRS-MTC). In some embodiments, the TDCP quantities are only computed or updated during each of the periodic TRS measurement windows (or each TRS-MTC), and the computed/updated TDCP quantity is valid until the next TRS measurement window. In some other embodiments, TDCP quantities are computed or updated during each of the TRS measurement window and the computed/updated TDCP quantity may be running average or weighted average of last N1 samples. In one example N1 may be equal to 3. In some example N1 may be equal to 1. In some embodiments the value of N1 may be indicated by a UE capability or NW configuration parameter.

In some embodiments, each TRS measurement window (or TRS-MTC) also has a duration or length T2. The duration or length may be configured via a higher layer parameter (e.g., RRC parameter). By configuring an appropriate duration for the TRS measurement window T2, the gNB can control how many TRS bursts are included in each TRS measurement window. This allows the gNB to control for what time lag values a TDCP quantity such as autocorrelation may be computed/updated. For instance, a larger duration or length of TRS measurement window allows more TRS bursts to be included in each TRS measurement window and hence allows autocorrelation to be computed for larger time lags. Note that larger duration or length of TRS measurement window also allows autocorrelation to be computed for small time lags as well.

On the contrary, a smaller duration or length of TRS measurement window allows fewer TRS bursts to be included in each TRS measurement window and hence allows autocorrelation to be computed for smaller time lags.

In some embodiments, the length of the TRS measurement window and/or the size of the time lags for which autocorrelation can be computed within the TRS measurement window is part of UE capability, and the specific capability on the length of the TRS measurement window and/or the size of the time lags for which autocorrelation can be computed for a given UE is reported to the network as part of UE capability.

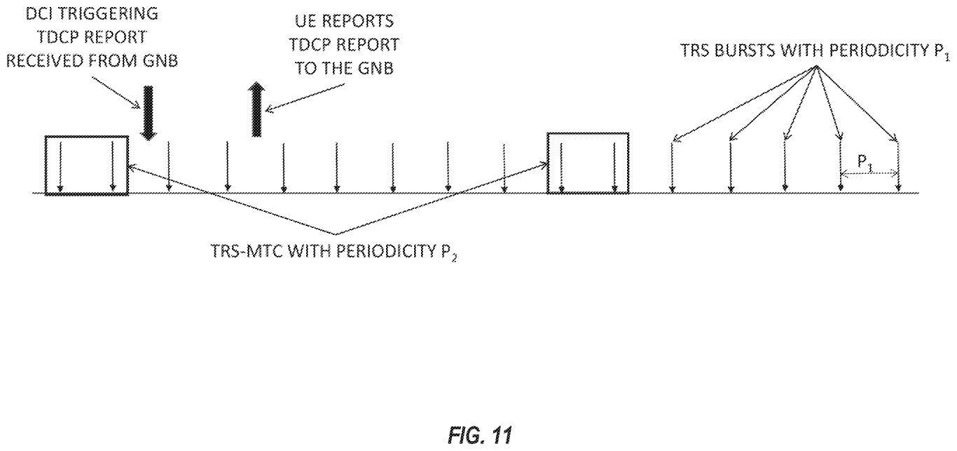

FIG. 11 illustrates an example showing aperiodic triggering of TDCP report where the TDCP quantities to be reported are measured using a periodic TRS-MTC. FIG. 11 shows an example of aperiodically triggered TDCP report that are based on measurements performed using a periodic TRS-MTC. As described above, the UE may compute/update the TDCP quantity to be reported in the TRS measurement window (or TRS-MTC). The gNB then triggers a DCI that requests the UE to feedback a TDCP report. The UE then feeds back the TDCP quantity computed/updated using the latest TRS measurement window (e.g., using the TRS measurement time window shown to the left of the DCI trigger in FIG. 11).

An example showing the higher layer signaling for a periodic TRS-MTC is shown in FIG. 10. As shown in the figure, the parameter ‘periodicityAndOffset’ in the TRS-MTC information element provides the periodicity and the slot offset for the periodic TRS-MTC. The higher layer parameter ‘duration’ provides the duration of each TRS measurement window. In some embodiments, the TRS measurement window may be configured as part of CSI-ReportConfig IE as defined in 3GPP TS 38.331 v17.1.0. Alternatively, the TRS measurement window may be configured as part of NZP-CSI-RS-ResourceSet IE as defined in 3GPP TS 38.331 v17.1.0 or as part of NZP-CSI-RS-Resource IE as defined in 3GPP TS 38.331 v17.1.0.

An example RRC configuration for a periodic TRS-MTC is shown below:

TRS-MTC information element

| -- ASN1START | |
|---|---|
| -- TAG-TRS-MTC-START | |
| TRS-MTC ::= | SEQUENCE { |
| periodicityAndOffset | CHOICE { |
| sf5 | INTEGER (0..4), |
| sf10 | INTEGER (0..9), |
| sf20 | INTEGER (0..19), |
| sf40 | INTEGER (0..39), |
| sf80 | INTEGER (0..79), |
| sf160 | INTEGER (0..159) |
| }, | |
| duration | ENUMERATED { sf1, |

sf2, sf3, sf4, sf5 }
}
-- TAG-TRS-MTC-STOP
-- ASN1STOP

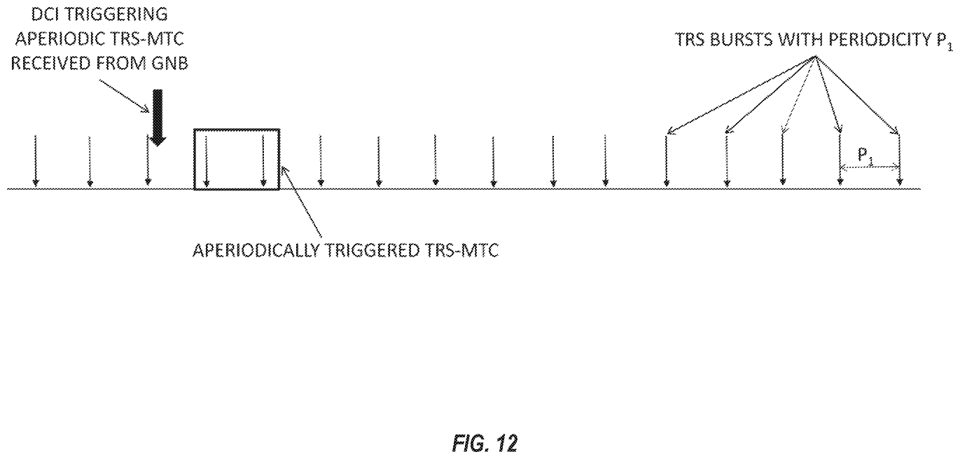

An example showing aperiodically triggered TRS-MTC is depicted in FIG. 12. The TRS measurement window or TRS-MTC in this example is triggered by the gNB via a DCI. Then, the UE may compute/update the TDCP quantities using TRS samples and/or TRS bursts within the aperiodically triggered TRS measurement window. Note that in some embodiments, the DCI that triggers the aperiodically triggered TRS measurement window is different from the DCI that triggers the aperiodic TDCP report. In an alternative embodiment, the DCI that triggers the aperiodically triggered TRS measurement window is the same as the DCI that triggers the aperiodic TDCP report.

Alternatively, instead of DCI, the gNB may use a MAC CE to activate the TRS measurement window (referred to as semi-persistent TRS measurement window). In this case, the TRS measurement window (note that the TRS measurement window may have a periodicity and offset as well as duration in this case) which are activated and deactivated by the gNB via a MAC CE. For instance, the gNB may send a first MAC CE to activate the semi-persistent TRS measurement window. The TRS measurement window with a periodicity/offset and duration will be active until a second MAC CE is sent by the gNB to deactivate the semi-persistent TRS measurement window. In this case, the UE will only perform computation/update of TDCP quantity when a semi-persistent TRS measurement window is active.

In one embodiment, the CPU occupation duration for TDCP report is determined with respect to the TRS measurement window. In one example, measurement and/or computation related to TDCP reporting quantity occupies CPU(s) from the first symbol of the earliest TRS burst/resource within the TRS measurement window, until latest symbol of TRS burst/resource within the TRS measurement window. A number of CPU(s) may be assumed to be consumed for measurement and/or computation related to TDCP reporting quantity during this duration. In one case, a single CPU may be assumed to be consumed for measurement and/or computation related to TDCP reporting quantity for a TRS resource configured for TDCP reporting.

In one embodiment, extra time is added to the last symbol of TRS within the TRS measurement window for CPU occupation. In one embodiment, instead of last TRS symbol within the active window, the last OFDM or downlink OFDM symbol within the window is used to determine CPU occupation duration. In another embodiment, the CPU assumed for measurement and/or computation related to TDCP reporting quantity is assumed for the whole duration of the TRS measurement window.

In one embodiment, if there's no available CPU(s) for an TRS measurement window, the TDCP reporting quantities are not required to be computed/updated.

In one embodiment, if UE is configured with DRX, and if the active measurement window for TDCP report is outside of DRX active time, TDCP quantiles are not required to be updated.

In some alternative embodiments, TDCP quantities are computed or update during all the TRS transmission occasions (i.e., not only during the TRS measurement window) and the computed/updated TDCP quantity may be running average or weighted average of last N₁ TDCP measurements. A benefit of this is that the UE can report a measurement very soon after receiving a measurement report trigger. This is of particular importance in the case that the measurement report trigger prevents another PUSCH from being scheduled until the report is sent. In some embodiments the value of N₁ may depend on the UE capability and/or NW configuration parameter. In some examples, if it is UE capability, N₁ value may depend on the UE capability to store and update the N₁ TDCP samples. In some examples, if the N₁ is based on the NW configuration parameter, N₁ may be 1 if the NW configures UE to consider only one TDCP measurement for the average. In some embodiments, N₁ may be a fixed value (e.g., 3) if the NW configures UE to consider average of more than one TDCP measurements to derive the TDCP measurement update. The NW configuration can be indicated by a parameter called timeRestrictionForTDCPMeasurements in the RRC message. In some other embodiments if the timeRestrictionForTDCPMeasurements is configured, N₁ is considered as 1. Else N₁ is considered as some other fixed value (e.g., 3).

In some other embodiments, N1 may be a variable and can be configured by RRC message.

A measurement report is typically based on several measurements performed at different points in time during the measurement window. Each of these measurements is based on the presence of the TRS in certain time symbols. As an example, a measurement of the autocorrelation for a certain autocorrelation lag (or time lag) requires the presence of the TRS in two symbols separated in time with that autocorrelation lag. The presence of TRS symbols suitable for a certain measurement is referred to as a measurement opportunity.

In some embodiments, the UE discards some of the measurements or measurement opportunities within the measurement window, due to one or more of the following reasons:
A phase jump occurred for the UE that invalidated the measurement or measurement opportunity (e.g., between the two TRS symbols to be used for an autocorrelation measurement)
The UE performed an RX-frequency adjustment that invalidated the measurement or measurement opportunity (e.g., between the two TRS symbols to be used for an autocorrelation measurement)
The UE processing capacity became overloaded and other processes where prioritized

In some embodiments the UE includes information in the measurement report on what measurements/measurement opportunities that have been discarded.

In some embodiments the UE includes information in the measurement report on what measurements/measurement opportunities that have been used.

In some embodiments, the TDCP measurements are autocorrelation measurements or some quantity that is calculated based on autocorrelation measurements for one or more autocorrelation lags. In some embodiments, the autocorrelation measure is defined by averaging

$${h}_{t} ( {t}_{k} + τ ) \cdot {h}_{n}^{*} ( {t}_{k} )$$

over time and frequency e.g., as:

$$c ( τ ) = \frac{1}{\vert M \vert \cdot \vert S \vert} {\sum }_{k ∈ M} {\sum }_{n ∈ S} {h}_{n} ( {t}_{k} + τ ) \cdot {h}_{n}^{*} ( {t}_{k} )$$

where n is a subcarrier index, S is a set of subcarrier indices with |S| elements, k is a time symbol index, M is a set of time symbol indices with |M| elements and hₙ(t) is the baseband channel for subcarrier n at time t. Since the summation both over time and frequency is coherent, this definition allows for measurement methods with very good noise suppression.

The UE may estimate this quantity using the defining formula above but replacing the channel hₙ(tₖ) with received frequency domain TRS samples after matched filtering, Xₙ(tₖ), and if needed, limiting the sets M and S to subcarriers and symbols carrying the TRS. The fact that the sums are coherent may provide some noise suppression. The coherency over frequency also allows for the use of further noise suppression techniques. The UE may e.g., perform the estimation in the time domain based on Yₗ defined as the IDFT of Xₙ as described in the background section.

In some other embodiments the autocorrelation measure is defined (using the same nomenclature) as:

$$c ( τ ) = \frac{1}{\vert M \vert \cdot \vert S \vert} {\sum }_{k ∈ M} \vert {\sum }_{n ∈ S} {h}_{n} ( {t}_{k} + τ ) \cdot {h}_{n}^{*} ( {t}_{k} ) \vert$$

This measure is independent of a phase jump occurring between time t and time t+τ, i.e hₙ(t+τ)→e^{ja}hₙ(t+τ) where the phase is independent of frequency/subcarrier). Such phase jumps may occur e.g., when the UE switch between DL reception and UL transmission or going in and out of sleep mode e.g., in order to save energy. Since the summation over subcarriers is coherent, this definition allows for measurement methods with good noise suppression.

The UE may estimate this quantity using the defining formula above but replacing the channel hₙ(tₖ) with received frequency domain TRS samples after matched filtering, Xₙ(tₖ), and if needed, limiting the sets M and S to subcarriers and symbols carrying the TRS. The fact that the sum over subcarriers is coherent may provide some noise suppression. The coherency over frequency also allows for the use of further noise suppression techniques. The UE may e.g., perform the estimation in the time domain based on Yₗ defined as the IDFT of Xₙ as described in the background section.

In some other embodiments the autocorrelation measure is defined (using the same nomenclature as above) as:

$$c ( τ ) = \frac{1}{\vert M \vert \cdot \vert S \vert} {\sum }_{k ∈ M} {\sum }_{n ∈ S} \vert {h}_{n} ( {t}_{k} + τ ) \cdot {h}_{n}^{*} ( {t}_{k} ) \vert$$

This measure is independent of a frequency change/adjustment being made between time t and time t+τ, resulting in a frequency dependent phase rotation on the form hₙ(t+τ)→e^{j(α+β·n)h}ₙ(t+τ).

The UE may estimate this quantity using the defining formula above but replacing the channel hₙ(tₖ) with received frequency domain TRS samples after matched filtering, Xₙ(tₖ), and if needed, limiting the sets M and S to subcarriers and symbols carrying the TRS. The fact that the sum is incoherent make it hard to apply noise suppression techniques.

In one embodiment the set S contains all subcarriers of the carrier. In another embodiment S is the set of subcarriers carrying the reference signal (e.g., the TRS) used for the autocorrelation estimate. This second embodiment has the benefit of being close to what the UE can actually measure and makes it easier to define requirements on UE measurement accuracies. To include all subcarriers in S may, however, be viewed as more theoretically correct and is also closer to the ideally wanted measure, since all subcarriers are used for communication. Note that even if all subcarriers are used in the definition of the quantity, the UE may utilize a subset of the subcarriers for the measurement.

In one embodiment the set M of symbol time indices consists of all symbol time indices k for which the symbol time tₖ is within a measurement period [a, b] i.e., indices k for which tₖ∈[a, b].

In another embodiment M is defined as the set of all symbol times tₖ within the measurement period [a, b], such that both symbol tₖ and tₖ+τ carry the reference signal(s) used for estimation of the autocorrelation. This second embodiment has the benefit of being close to what the UE can actually measure and makes it easier to define requirements on UE measurement accuracies. To include all symbol times within the measurement period may, however, be viewed as more theoretically correct and is also closer to the ideally wanted measure, since all symbols are used for communication. Note that even if all time symbols within the measurement period are used in the definition of the quantity, the UE may utilize a subset of the time symbols for the measurement.

In some embodiments the UE reports measurements of one of the following quantities:

$$\frac{c ( τ )}{c ( 0 )} ,$$

i.e., the normalized autocorrelation function

$$\vert \frac{c ( τ )}{c ( 0 )} \vert ,$$

i.e., the absolute value of the normalized autocorrelation function

$$sign ( re ( c ( τ ) ) ) \vert \frac{c ( τ )}{c ( 0 )} \vert ,$$

i.e., the sign of the real part of the autocorrelation times the absolute value of the normalized autocorrelation function for one or more autocorrelation lags T.

In yet another set of embodiments, the autocorrelation measure is defined as one of:

$$c ( τ ) = \frac{1}{\vert M \vert} {\sum }_{k ∈ M} \frac{2 \cdot {\sum }_{n ∈ S} {h}_{n} ( {t}_{k} + τ ) \cdot {h}_{n}^{*} ( {t}_{k} )}{{\sum }_{n ∈ S} ( {h}_{n} ( {t}_{k} ) \cdot {h}_{n}^{*} ( {t}_{k} ) + {h}_{n} ( {t}_{k} + τ ) \cdot {h}_{n}^{*} ( {t}_{k} + τ ) )} \qquad a )$$

$$c ( τ ) = \frac{1}{\vert M \vert} {\sum }_{k ∈ M} \frac{2 \cdot \vert {\sum }_{n ∈ S} {h}_{n} ( {t}_{k} + τ ) \cdot {h}_{n}^{*} ( {t}_{k} ) \vert}{{\sum }_{n ∈ S} ( {h}_{n} ( {t}_{k} ) \cdot {h}_{n}^{*} ( {t}_{k} ) + {h}_{n} ( {t}_{k} + τ ) \cdot {h}_{n}^{*} ( {t}_{k} + τ ) )} \qquad b )$$

$$c ( τ ) = \frac{1}{\vert M \vert} {\sum }_{k ∈ M} \frac{2 \cdot {\sum }_{n ∈ S} \vert {h}_{n} ( {t}_{k} + τ ) \cdot {h}_{n}^{*} ( {t}_{k} ) \vert}{{\sum }_{n ∈ S} ( {h}_{n} ( {t}_{k} ) \cdot {h}_{n}^{*} ( {t}_{k} ) + {h}_{n} ( {t}_{k} + τ ) \cdot {h}_{n}^{*} ( {t}_{k} + τ ) )} \qquad c )$$

For these measures normalization is performed before averaging over time and c(0)=1. In yet another set of embodiments the autocorrelation measure is defined as one of

$$c ( τ ) = \frac{1}{\vert M \vert} {\sum }_{k ∈ M} {\sum }_{n ∈ S} \frac{2 \cdot {h}_{n} ( {t}_{k} + τ ) \cdot {h}_{n}^{*} ( {t}_{k} )}{{h}_{n} ( {t}_{k} ) \cdot {h}_{n}^{*} ( {t}_{k} ) + {h}_{n} ( {t}_{k} + τ ) \cdot {h}_{n}^{*} ( {t}_{k} + τ )} \qquad a )$$

$$c ( τ ) = \frac{1}{\vert M \vert} {\sum }_{k ∈ M} \vert {\sum }_{n ∈ S} \frac{2 \cdot {h}_{n} ( {t}_{k} + τ ) \cdot {h}_{n}^{*} ( {t}_{k} )}{{h}_{n} ( {t}_{k} ) \cdot {h}_{n}^{*} ( {t}_{k} ) + {h}_{n} ( {t}_{k} + τ ) \cdot {h}_{n}^{*} ( {t}_{k} + τ )} \vert \qquad b )$$

$$c ( τ ) = \frac{1}{\vert M \vert} {\sum }_{k ∈ M} {\sum }_{n ∈ S} \frac{\vert 2 \cdot {h}_{n} ( {t}_{k} + τ ) \cdot {h}_{n}^{*} ( {t}_{k} ) \vert}{{h}_{n} ( {t}_{k} ) \cdot {h}_{n}^{*} ( {t}_{k} ) + {h}_{n} ( {t}_{k} + τ ) \cdot {h}_{n}^{*} ( {t}_{k} + τ )} \qquad c )$$

For these measures normalization is performed before averaging over time and frequency and c(0)=1.

In another alternative embodiments, where TDCP reporting quantities are computed or updated during the TRS transmission occasions selected by the UE (i.e., when to measure TDCP among the TRS occasions may be up to UE implementation), the TDCP report sent by the UE at time unit n, shall be based on the TRS occasions within n and n-timeWindow. That means UE shall not send TDCP report which was measured more than certain time (e.g., timeWindow) from the TDCP request occasion from the NW node.

In some embodiments, combination of the above-mentioned embodiments may be selected to arrive at a solution.

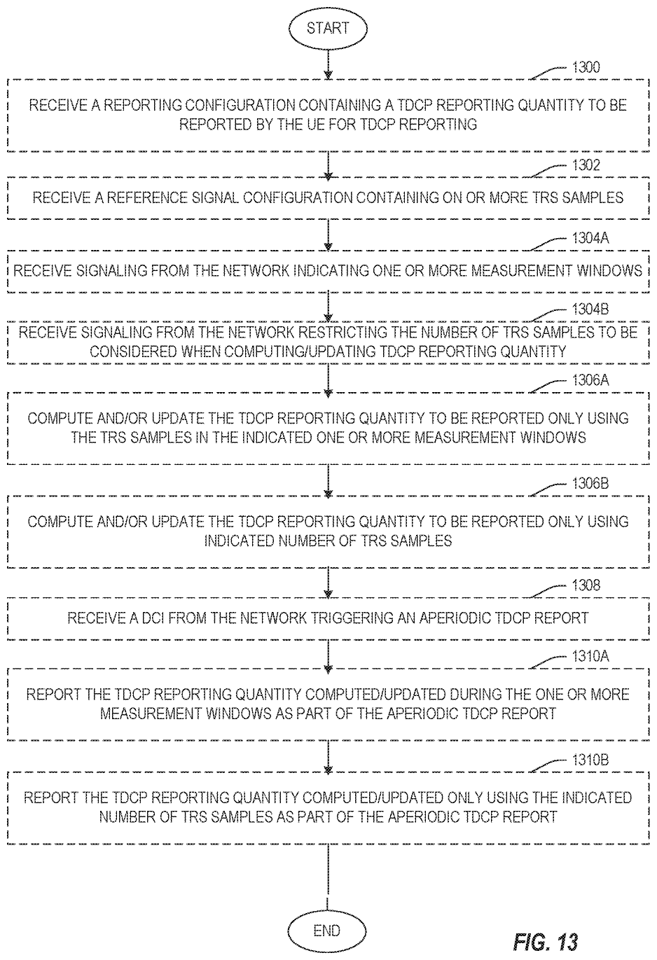

FIG. 13 illustrates a method performed by a UE for TDCP reporting based on measurement on TRS samples. In some embodiments, the method includes one or more of: receiving (step 1300) from a network a reporting configuration containing a TDCP reporting quantity to be reported by the UE for TDCP reporting; receiving (step 1302) from the network a reference signal configuration containing one or more TRS samples; receiving (step 1304A) signaling from the network indicating one or more measurement windows; receiving (step 1304B) signaling from the network restricting the number of TRS samples to be considered when computing/updating TDCP reporting quantity; computing and/or updating (step 1306A) the TDCP reporting quantity to be reported only using the TRS samples in the indicated one or more measurement windows; computing and/or updating (step 1306B) the TDCP reporting quantity to be reported only using indicated number of TRS samples; receiving (step 1308) a DCI from the network triggering an aperiodic TDCP report; reporting (step 1310A) the TDCP reporting quantity computed/updated during the one or more measurement windows as part of the aperiodic TDCP report; and reporting (step 1310B) the TDCP reporting quantity computed/updated only using the indicated number of TRS samples as part of the aperiodic TDCP report.

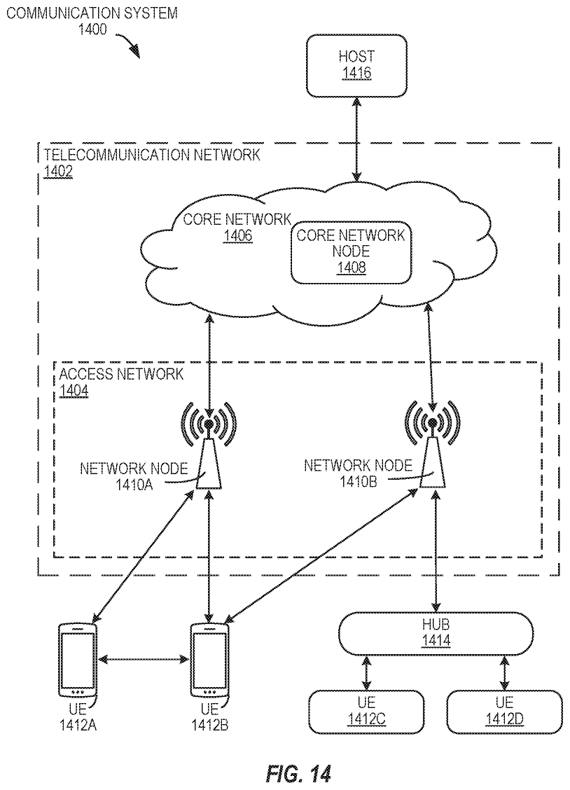

FIG. 14 shows an example of a communication system 1400 in accordance with some embodiments.

In the example, the communication system 1400 includes a telecommunication network 1402 that includes an access network 1404, such as a Radio Access Network (RAN), and a core network 1406, which includes one or more core network nodes 1408. The access network 1404 includes one or more access network nodes, such as network nodes 1410A and 1410B (one or more of which may be generally referred to as network nodes 1410), or any other similar Third Generation Partnership Project (3GPP) access node or non-3GPP Access Point (AP). The network nodes 1410 facilitate direct or indirect connection of User Equipment (UE), such as by connecting UEs 1412A, 1412B, 1412C, and 1412D (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, including wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402 and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system 1400 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1402 is a cellular network that implements 3GPP standardized features. Accordingly, the telecommunication network 1402 may support network slicing to provide different logical networks to different devices that are connected to the telecommunication network 1402. For example, the telecommunication network 1402 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 1414 communicates with the access network 1404 to facilitate indirect communication between one or more UEs (e.g., UE 1412C and/or 1412D) and network nodes (e.g., network node 1410B). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a Virtual Reality (VR) headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410B. The hub 1414 may also allow for a different communication scheme and/or schedule between the hub 1414 and UEs (e.g., UE 1412C and/or 1412D), and between the hub 1414 and the core network 1406. In other examples, the hub 1414 is connected to the core network 1406 and/or one or more UEs via a wired connection. Moreover, the hub 1414 may be configured to connect to a Machine-to-Machine (M2M) service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410B. In other embodiments, the hub 1414 may be a non-dedicated hub—that is, a device which is capable of operating to route communications between the UEs and the network node 1410B, but which is additionally capable of operating as a communication start and/or end point for certain data channels.

FIG. 15 shows a UE 1500 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1500 includes processing circuitry 1502 that is operatively coupled via a bus 1504 to an input/output interface 1506, a power source 1508, memory 1510, a communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1502 may include multiple Central Processing Units (CPUs).

In the example, the input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g., an electricity outlet), photovoltaic device, or power cell, may be used. The power source 1508 may further include power circuitry for delivering power from the power source 1508 itself, and/or an external power source, to the various parts of the UE 1500 via input circuitry or an interface such as an electrical power cable. Delivering power may be, for example, for charging the power source 1508. Power circuitry may perform any formatting, converting, or other modification to the power from the power source 1508 to make the power suitable for the respective components of the UE 1500 to which power is supplied.

The memory 1510 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the UE 1500, any of a variety of various operating systems or combinations of operating systems.

The memory 1510 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1510 may allow the UE 1500 to access instructions, application programs, and the like stored on transitory or non-transitory memory media, to off-load data, or to upload data. An article of manufacture, such as one utilizing a communication system, may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g., another UE or a network node in an access network). Each transceiver may include a transmitter 1518 and/or a receiver 1520 appropriate to provide network communications (e.g., optical, electrical, frequency allocations, and so forth). Moreover, the transmitter 1518 and receiver 1520 may be coupled to one or more antennas (e.g., the antenna 1522) and may share circuit components, software, or firmware, or alternatively be implemented separately.

In the illustrated embodiment, communication functions of the communication interface 1512 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1512, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1500 shown in FIG. 15.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

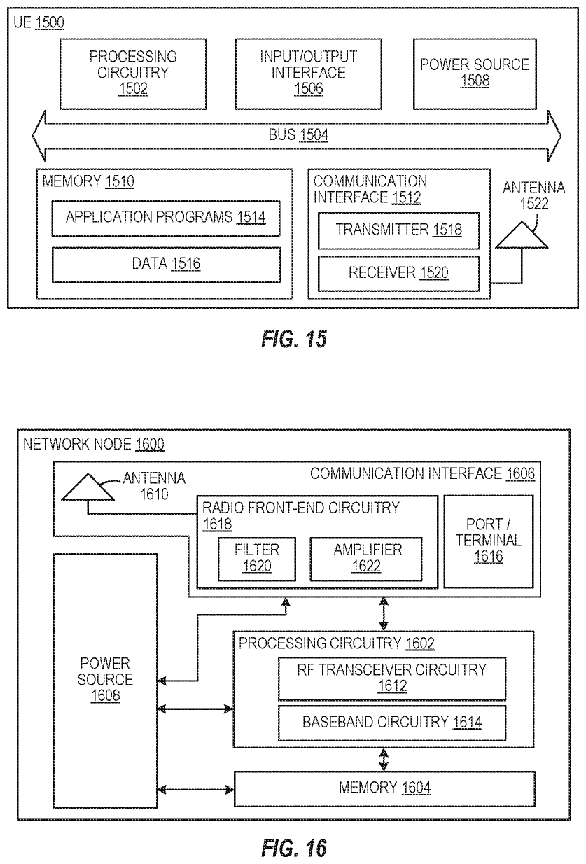

FIG. 16 shows a network node 1600 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1600 includes processing circuitry 1602, memory 1604, a communication interface 1606, and a power source 1608. The network node 1600 may be composed of multiple physically separate components (e.g., a Node B component and an RNC component, or a BTS component and a BSC component, etc.), which may each have their own respective components. In certain scenarios in which the network node 1600 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1600 may be configured to support multiple RATs. In such embodiments, some components may be duplicated (e.g., separate memory 1604 for different RATs) and some components may be reused (e.g., an antenna 1610 may be shared by different RATs). The network node 1600 may also include multiple sets of the various illustrated components for different wireless technologies integrated into network node 1600, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1600.

The processing circuitry 1602 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1600 components, such as the memory 1604, to provide network node 1600 functionality.

In some embodiments, the processing circuitry 1602 includes a System on a Chip (SOC). In some embodiments, the processing circuitry 1602 includes one or more of Radio Frequency (RF) transceiver circuitry 1612 and baseband processing circuitry 1614. In some embodiments, the RF transceiver circuitry 1612 and the baseband processing circuitry 1614 may be on separate chips (or sets of chips), boards, or units, such as radio units and digital units. In alternative embodiments, part or all of the RF transceiver circuitry 1612 and the baseband processing circuitry 1614 may be on the same chip or set of chips, boards, or units.

The memory 1604 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and the memory 1604 are integrated.

The communication interface 1606 is used in wired or wireless communication of signaling and/or data between a network node, access network, and/or UE. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. The radio front-end circuitry 1618 comprises filters 1620 and amplifiers 1622. The radio front-end circuitry 1618 may be connected to the antenna 1610 and the processing circuitry 1602. The radio front-end circuitry 1618 may be configured to condition signals communicated between the antenna 1610 and the processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of the filters 1620 and/or the amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface 1606 may comprise different components and/or different combinations of components.

In certain alternative embodiments, the network node 1600 does not include separate radio front-end circuitry 1618; instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes the one or more ports or terminals 1616, the radio front-end circuitry 1618, and the RF transceiver circuitry 1612 as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, the communication interface 1606, and/or the processing circuitry 1602 may be configured to perform any receiving operations and/or certain obtaining operations described herein as being performed by the network node 1600. Any information, data, and/or signals may be received from a UE, another network node, and/or any other network equipment. Similarly, the antenna 1610, the communication interface 1606, and/or the processing circuitry 1602 may be configured to perform any transmitting operations described herein as being performed by the network node 1600. Any information, data, and/or signals may be transmitted to a UE, another network node, and/or any other network equipment.

The power source 1608 provides power to the various components of the network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., the power grid or an electricity outlet) via input circuitry or an interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 16 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

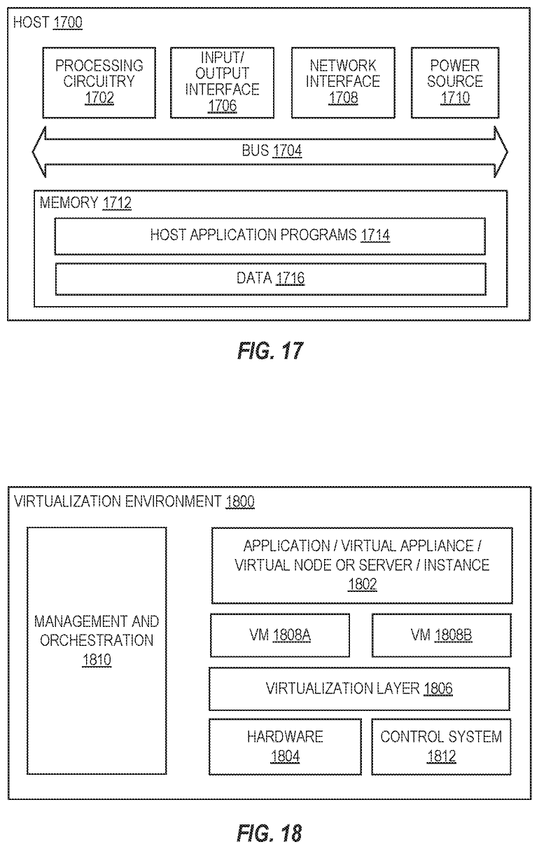

FIG. 17 is a block diagram of a host 1700, which may be an embodiment of the host 1416 of FIG. 14, in accordance with various aspects described herein. As used herein, the host 1700 may be or comprise various combinations of hardware and/or software including a standalone server, a blade server, a cloud-implemented server, a distributed server, a virtual machine, container, or processing resources in a server farm. The host 1700 may provide one or more services to one or more UEs.

The host 1700 includes processing circuitry 1702 that is operatively coupled via a bus 1704 to an input/output interface 1706, a network interface 1708, a power source 1710, and memory 1712. Other components may be included in other embodiments. Features of these components may be substantially similar to those described with respect to the devices of previous figures, such as FIGS. 15 and 16, such that the descriptions thereof are generally applicable to the corresponding components of the host 1700.

The memory 1712 may include one or more computer programs including one or more host application programs 1714 and data 1716, which may include user data, e.g., data generated by a UE for the host 1700 or data generated by the host 1700 for a UE. Embodiments of the host 1700 may utilize only a subset or all of the components shown. The host application programs 1714 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1714 may also provide for user authentication and licensing checks and may periodically report health, routes, and content availability to a central node, such as a device in or on the edge of a core network. Accordingly, the host 1700 may select and/or indicate a different host for Over-The-Top (OTT) services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in the virtualization environment 1700 to implement some of the features, functions, and/or benefits of some of the embodiments disclosed herein.

Hardware 1804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1806 (also referred to as hypervisors or VM Monitors (VMMs)), provide VMs 1808A and 1808B (one or more of which may be generally referred to as VMs 1808), and/or perform any of the functions, features, and/or benefits described in relation with some embodiments described herein. The virtualization layer 1806 may present a virtual operating platform that appears like networking hardware to the VMs 1808.

The VMs 1808 comprise virtual processing, virtual memory, virtual networking, or interface and virtual storage, and may be run by a corresponding virtualization layer 1806. Different embodiments of the instance of a virtual appliance 1802 may be implemented on one or more of the VMs 1808, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1808 may be a software implementation of a physical machine that runs programs as if they were executing on a physical, non-virtualized machine. Each of the VMs 1808, and that part of the hardware 1804 that executes that VM, be it hardware dedicated to that VM and/or hardware shared by that VM with others of the VMs 1808, forms separate virtual network elements. Still in the context of NFV, a virtual network function is responsible for handling specific network functions that run in one or more VMs 1808 on top of the hardware 1804 and corresponds to the application 1802.

The hardware 1804 may be implemented in a standalone network node with generic or specific components. The hardware 1804 may implement some functions via virtualization. Alternatively, the hardware 1804 may be part of a larger cluster of hardware (e.g., such as in a data center or CPE) where many hardware nodes work together and are managed via management and orchestration 1810, which, among others, oversees lifecycle management of the applications 1802. In some embodiments, the hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1812 which may alternatively be used for communication between hardware nodes and radio units.

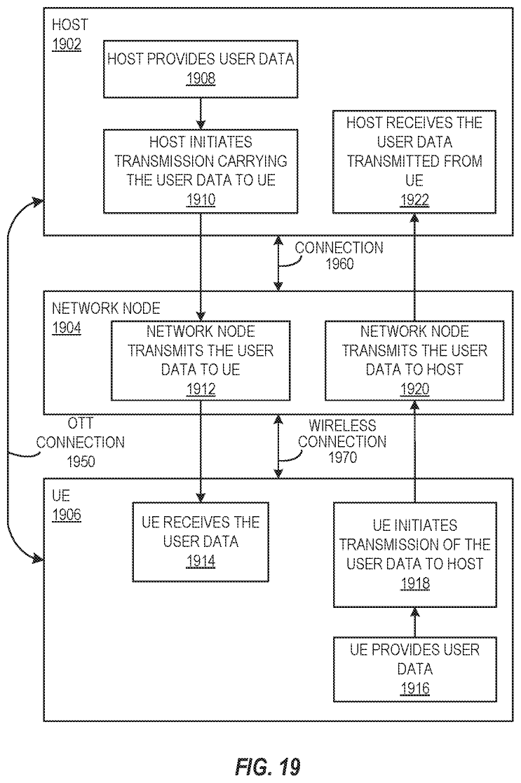

FIG. 19 shows a communication diagram of a host 1902 communicating via a network node 1904 with a UE 1906 over a partially wireless connection in accordance with some embodiments. Example implementations, in accordance with various embodiments, of the UE (such as the UE 1412A of FIG. 14 and/or the UE 1500 of FIG. 15), the network node (such as the network node 1410A of FIG. 14 and/or the network node 1600 of FIG. 16), and the host (such as the host 1416 of FIG. 14 and/or the host 1700 of FIG. 17) discussed in the preceding paragraphs will now be described with reference to FIG. 19.

Like the host 1700, embodiments of the host 1902 include hardware, such as a communication interface, processing circuitry, and memory. The host 1902 also includes software, which is stored in or is accessible by the host 1902 and executable by the processing circuitry. The software includes a host application that may be operable to provide a service to a remote user, such as the UE 1906 connecting via an OTT connection 1950 extending between the UE 1906 and the host 1902. In providing the service to the remote user, a host application may provide user data which is transmitted using the OTT connection 1950.

The network node 1904 includes hardware enabling it to communicate with the host 1902 and the UE 1906 via a connection 1960. The connection 1960 may be direct or pass through a core network (like the core network 1406 of FIG. 14) and/or one or more other intermediate networks, such as one or more public, private, or hosted networks. For example, an intermediate network may be a backbone network or the Internet.

The UE 1906 includes hardware and software, which is stored in or accessible by the UE 1906 and executable by the UE's processing circuitry. The software includes a client application, such as a web browser or operator-specific “app” that may be operable to provide a service to a human or non-human user via the UE 1906 with the support of the host 1902. In the host 1902, an executing host application may communicate with the executing client application via the OTT connection 1950 terminating at the UE 1906 and the host 1902. In providing the service to the user, the UE's client application may receive request data from the host's host application and provide user data in response to the request data. The OTT connection 1950 may transfer both the request data and the user data. The UE's client application may interact with the user to generate the user data that it provides to the host application through the OTT connection 1950.

The OTT connection 1950 may extend via the connection 1960 between the host 1902 and the network node 1904 and via a wireless connection 1970 between the network node 1904 and the UE 1906 to provide the connection between the host 1902 and the UE 1906. The connection 1960 and the wireless connection 1970, over which the OTT connection 1950 may be provided, have been drawn abstractly to illustrate the communication between the host 1902 and the UE 1906 via the network node 1904, without explicit reference to any intermediary devices and the precise routing of messages via these devices.

As an example of transmitting data via the OTT connection 1950, in step 1908, the host 1902 provides user data, which may be performed by executing a host application. In some embodiments, the user data is associated with a particular human user interacting with the UE 1906. In other embodiments, the user data is associated with a UE 1906 that shares data with the host 1902 without explicit human interaction. In step 1910, the host 1902 initiates a transmission carrying the user data towards the UE 1906. The host 1902 may initiate the transmission responsive to a request transmitted by the UE 1906. The request may be caused by human interaction with the UE 1906 or by operation of the client application executing on the UE 1906. The transmission may pass via the network node 1904 in accordance with the teachings of the embodiments described throughout this disclosure. Accordingly, in step 1912, the network node 1904 transmits to the UE 1906 the user data that was carried in the transmission that the host 1902 initiated, in accordance with the teachings of the embodiments described throughout this disclosure. In step 1914, the UE 1906 receives the user data carried in the transmission, which may be performed by a client application executed on the UE 1906 associated with the host application executed by the host 1902.

In some examples, the UE 1906 executes a client application which provides user data to the host 1902. The user data may be provided in reaction or response to the data received from the host 1902. Accordingly, in step 1916, the UE 1906 may provide user data, which may be performed by executing the client application. In providing the user data, the client application may further consider user input received from the user via an input/output interface of the UE 1906. Regardless of the specific manner in which the user data was provided, the UE 1906 initiates, in step 1918, transmission of the user data towards the host 1902 via the network node 1904. In step 1920, in accordance with the teachings of the embodiments described throughout this disclosure, the network node 1904 receives user data from the UE 1906 and initiates transmission of the received user data towards the host 1902. In step 1922, the host 1902 receives the user data carried in the transmission initiated by the UE 1906.

One or more of the various embodiments improve the performance of OTT services provided to the UE 1906 using the OTT connection 1950, in which the wireless connection 1970 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1902. As another example, the host 1902 may process audio and video data which may have been retrieved from a UE for use in creating maps. As another example, the host 1902 may collect and analyze real-time data to assist in controlling vehicle congestion (e.g., controlling traffic lights). As another example, the host 1902 may store surveillance video uploaded by a UE. As another example, the host 1902 may store or control access to media content such as video, audio, VR, or AR which it can broadcast, multicast, or unicast to UEs. As other examples, the host 1902 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1950 between the host 1902 and the UE 1906 in response to variations in the measurement results. The measurement procedure and/or the network functionality for reconfiguring the OTT connection 1950 may be implemented in software and hardware of the host 1902 and/or the UE 1906. In some embodiments, sensors (not shown) may be deployed in or in association with other devices through which the OTT connection 1950 passes; the sensors may participate in the measurement procedure by supplying values of the monitored quantities exemplified above, or by supplying values of other physical quantities from which software may compute or estimate the monitored quantities. The reconfiguring of the OTT connection 1950 may include message format, retransmission settings, preferred routing, etc.; the reconfiguring need not directly alter the operation of the network node 1904. Such procedures and functionalities may be known and practiced in the art. In certain embodiments, measurements may involve proprietary UE signaling that facilitates measurements of throughput, propagation times, latency, and the like by the host 1902. The measurements may be implemented in that software causes messages to be transmitted, in particular empty or ‘dummy’ messages, using the OTT connection 1950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole and/or by end users and a wireless network generally.

### Embodiments

### Group A Embodiments

Embodiment 1: A method performed by a User Equipment, UE, for Time Domain Channel Properties, TDCP, reporting based on measurement on Tracking Reference Signal, TRS, samples, the method comprising one or more of: a. receiving (1300) from a network a reporting configuration containing a TDCP reporting quantity to be reported by the UE for TDCP reporting; b. receiving (1302) from the network a reference signal configuration containing on or more TRS samples; c. receiving (1304A) signaling from the network indicating one or more measurement windows; d. receiving (1304B) signaling from the network restricting the number of TRS samples to be considered when computing/updating TDCP reporting quantity; e. computing and/or updating (1306A) the TDCP reporting quantity to be reported only using the TRS samples in the indicated one or more measurement windows; f.
computing and/or updating (1306B) the TDCP reporting quantity to be reported only using indicated number of TRS samples; g. receiving (1308) a DCI from the network triggering an aperiodic TDCP report; h. reporting (1310A) the TDCP reporting quantity computed/updated during the one or more measurement windows as part of the aperiodic TDCP report; and i.
reporting (1310B) the TDCP reporting quantity computed/updated only using the indicated number of TRS samples as part of the aperiodic TDCP report.

Embodiment 2: The method of the previous embodiment wherein: the TDCP reporting quantity comprises one or more of: different type of autocorrelation-based reporting quantities; Doppler spread ƒ_{d}; a running average of last N₁ samples; a weighted average of last N₁ samples; etc.

Embodiment 3: The method of any of the previous embodiments wherein N₁ is equal to: 3; 1; indicated by a UE capability; or indicated by a network configuration parameter.

Embodiment 4: The method of any of the previous embodiments wherein the network configuration of N₁ is indicated by a parameter called timeRestrcitionForTDCPMeasurements in the RRC message.

Embodiment 5: The method of any of the previous embodiments wherein if the timeRestrcitionForTDCPMeasurements is configured, N₁ is considered as 1.

Embodiment 6: The method of any of the previous embodiments wherein N₁ is configured by RRC message.

Embodiment 7: The method of any of the previous embodiments wherein the signaling comprises one or more of: periodic measurement windows; aperiodically triggered measurement windows; and semi-persistently activated TRS windows.

Embodiment 8: The method of any of the previous embodiments further including: determining to discard some of the measurements or measurement opportunities within the measurement window.

Embodiment 9: The method of any of the previous embodiments further including: determining a number of CPUs occupied for measurements and computation related to TDCP reporting.

Embodiment 10: The method of any of the previous embodiments wherein the measurement window comprises: being configured with TRS Measurement Time Configuration, TRS-MTC, where the UE is only required to compute/update the TDCP quantities using the TRS samples and/or TRS bursts within the configured measurement time.

Embodiment 11: The method of any of the previous embodiments wherein the TDCP quantities are only computed or updated during each of the periodic TRS measurement windows, and the computed/updated TDCP quantity is valid until the next TRS measurement window.

Embodiment 12: The method of any of the previous embodiments wherein each TRS measurement window has a duration or length T₂.

Embodiment 13: The method of any of the previous embodiments wherein the duration or length T2 is configured via a higher layer parameter (e.g., RRC parameter).

Embodiment 14: The method of any of the previous embodiments wherein the length of the TRS measurement window and/or the size of the time lags for which autocorrelation can be computed within the TRS measurement window is part of UE capability.

Embodiment 15: The method of any of the previous embodiments wherein the specific capability on the length of the TRS measurement window and/or the size of the time lags for which autocorrelation can be computed for a given UE is reported to the network as part of UE capability.

Embodiment 16: The method of any of the previous embodiments wherein the TRS measurement window may be configured as part of CSI-ReportConfig IE.

Embodiment 17: The method of any of the previous embodiments wherein the DCI that triggers the aperiodically triggered TRS measurement window is different from the DCI that triggers the aperiodic TDCP report.

Embodiment 18: The method of any of the previous embodiments wherein the DCI that triggers the aperiodically triggered TRS measurement window is the same as the DCI that triggers the aperiodic TDCP report.

Embodiment 19: The method of any of the previous embodiments wherein the CPU occupation duration for TDCP report is determined with respect to the TRS measurement window.

Embodiment 20: The method of any of the previous embodiments wherein extra time is added to the last symbol of TRS within the TRS measurement window for CPU occupation.

Embodiment 21: The method of any of the previous embodiments wherein the last OFDM or downlink OFDM symbol within the window is used to determine CPU occupation duration.

Embodiment 22: The method of any of the previous embodiments wherein the CPU assumed for measurement and/or computation related to TDCP reporting quantity is assumed for the whole duration of the TRS measurement window.

Embodiment 23: The method of any of the previous embodiments wherein if there's no available CPU(s) for an TRS measurement window, the TDCP reporting quantities are not required to be computed/updated.

Embodiment 24: The method of any of the previous embodiments wherein if UE is configured with DRX, and if the active measurement window for TDCP report is outside of DRX active time, TDCP quantiles are not required to be updated.

Embodiment 25: The method of any of the previous embodiments wherein the UE discards some of the measurements or measurement opportunities within the measurement window, due to one or more of the following reasons: a. a phase jump occurred for the UE that invalidated the measurement or measurement opportunity; b. the UE performed an RX-frequency adjustment that invalidated the measurement or measurement opportunity; and c.
the UE processing capacity became overloaded and other processes where prioritized.

Embodiment 26: The method of any of the previous embodiments wherein the UE includes information in the measurement report on what measurements/measurement opportunities that have been discarded.

Embodiment 27: The method of any of the previous embodiments wherein the UE includes information in the measurement report on what measurements/measurement opportunities that have been used.

Embodiment 28: The method of any of the previous embodiments wherein the TDCP measurements are autocorrelation measurements or some quantity that is calculated based on autocorrelation measurements for one or more autocorrelation lags.

Embodiment 29: The method of any of the previous embodiments wherein the autocorrelation measure is defined by averaging

$${h}_{n} ( {t}_{k} + τ ) \cdot {h}_{n}^{*} ( {t}_{k} )$$

over time and frequency.

Embodiment 30: The method of any of the previous embodiments wherein the UE reports measurements of one or more of the following quantities:

$$a . \frac{c ( τ )}{c ( 0 )} ,$$

e.g., the normalized autocorrelation function;

$$b . \vert \frac{c ( τ )}{c ( 0 )} \vert ,$$

e.g., the absolute value of the normalized autocorrelation function; and c.

$$sign ( re ( c ( τ ) ) ) \vert \frac{c ( τ )}{c ( 0 )} \vert ,$$

e.g., the sign of the real part of the autocorrelation times the absolute value of the normalized autocorrelation function.

Embodiment 31: The method of any of the previous embodiments, further comprising: providing user data; and forwarding the user data to a host via the transmission to the network node.

### Group B Embodiments

Embodiment 32: A method performed by a network node for receiving Time Domain Channel Properties, TDCP, reporting based on measurement on Tracking Reference Signal, TRS, samples, the method comprising: a. transmitting (1300) to a User Equipment, UE, a reporting configuration containing a TDCP reporting quantity to be reported by the UE for TDCP reporting; b. transmitting (1302) to the UE a reference signal configuration containing on or more TRS samples; c. transmitting (1304A) signaling to the UE indicating one or more measurement windows; d. transmitting (1304B) signaling to the UE restricting the number of TRS samples to be considered when computing/updating TDCP reporting quantity; e.transmitting (1308) a DCI to the UE triggering an aperiodic TDCP report; f.
receiving (1310A) the TDCP reporting quantity computed/updated during the one or more measurement windows as part of the aperiodic TDCP report; and g. receiving (1310B) the TDCP reporting quantity computed/updated only using the indicated number of TRS samples as part of the aperiodic TDCP report.

Embodiment 33: The method of the previous embodiment wherein: the TDCP reporting quantity comprises one or more of: different type of autocorrelation-based reporting quantities; Doppler spread ƒ_{d}; a running average of last N₁ samples; a weighted average of last N₁ samples; etc.

Embodiment 34: The method of any of the previous embodiments wherein N₁ is equal to: 3; 1; indicated by a UE capability; or indicated by a network configuration parameter.

Embodiment 35: The method of any of the previous embodiments wherein the network configuration of N₁ is indicated by a parameter called timeRestrcitionForTDCPMeasurements in the RRC message.

Embodiment 36: The method of any of the previous embodiments wherein if the timeRestrcitionForTDCPMeasurements is configured, N₁ is considered as 1.

Embodiment 37: The method of any of the previous embodiments wherein N₁ is configured by RRC message.

Embodiment 38: The method of any of the previous embodiments wherein the signaling comprises one or more of: periodic measurement windows; aperiodically triggered measurement windows; and semi-persistently activated TRS windows.

Embodiment 39: The method of any of the previous embodiments wherein the measurement window comprises: being configured with TRS Measurement Time Configuration, TRS-MTC, where the UE is only required to compute/update the TDCP quantities using the TRS samples and/or TRS bursts within the configured measurement time.

Embodiment 40: The method of any of the previous embodiments wherein the TDCP quantities are only computed or updated during each of the periodic TRS measurement windows, and the computed/updated TDCP quantity is valid until the next TRS measurement window.

Embodiment 41: The method of any of the previous embodiments wherein each TRS measurement window has a duration or length T₂.

Embodiment 42: The method of any of the previous embodiments wherein the duration or length T₂ is configured via a higher layer parameter (e.g., RRC parameter).

Embodiment 43: The method of any of the previous embodiments wherein the length of the TRS measurement window and/or the size of the time lags for which autocorrelation can be computed within the TRS measurement window is part of UE capability.

Embodiment 44: The method of any of the previous embodiments wherein the specific capability on the length of the TRS measurement window and/or the size of the time lags for which autocorrelation can be computed for a given UE is reported to the network as part of UE capability.

Embodiment 45: The method of any of the previous embodiments wherein the TRS measurement window may be configured as part of CSI-ReportConfig IE.

Embodiment 46: The method of any of the previous embodiments wherein the DCI that triggers the aperiodically triggered TRS measurement window is different from the DCI that triggers the aperiodic TDCP report.

Embodiment 47: The method of any of the previous embodiments wherein the DCI that triggers the aperiodically triggered TRS measurement window is the same as the DCI that triggers the aperiodic TDCP report.

Embodiment 48: The method of any of the previous embodiments wherein the CPU occupation duration for TDCP report is determined with respect to the TRS measurement window.

Embodiment 49: The method of any of the previous embodiments wherein extra time is added to the last symbol of TRS within the TRS measurement window for CPU occupation.

Embodiment 50: The method of any of the previous embodiments wherein the last OFDM or downlink OFDM symbol within the window is used to determine CPU occupation duration.

Embodiment 51: The method of any of the previous embodiments wherein the CPU assumed for measurement and/or computation related to TDCP reporting quantity is assumed for the whole duration of the TRS measurement window.

Embodiment 52: The method of any of the previous embodiments wherein if there's no available CPU(s) for an TRS measurement window, the TDCP reporting quantities are not required to be computed/updated.

Embodiment 53: The method of any of the previous embodiments wherein if UE is configured with DRX, and if the active measurement window for TDCP report is outside of DRX active time, TDCP quantiles are not required to be updated.

Embodiment 54: The method of any of the previous embodiments wherein the UE includes information in the measurement report on what measurements/measurement opportunities that have been discarded.

Embodiment 55: The method of any of the previous embodiments wherein the UE includes information in the measurement report on what measurements/measurement opportunities that have been used.

Embodiment 56: The method of any of the previous embodiments wherein the TDCP measurements are autocorrelation measurements or some quantity that is calculated based on autocorrelation measurements for one or more autocorrelation lags.

Embodiment 57: The method of any of the previous embodiments wherein the autocorrelation measure is defined by averaging

$${h}_{n} ( {t}_{k} + τ ) \cdot {h}_{n}^{*} ( {t}_{k} )$$

over time and frequency.

Embodiment 58: The method of any of the previous embodiments wherein the UE reports measurements of one or more of the following quantities:

$$a . \frac{c ( τ )}{c ( 0 )} ,$$

e.g., the normalized autocorrelation function;

$$b . \vert \frac{c ( τ )}{c ( 0 )} \vert ,$$

e.g., the absolute value of the normalized autocorrelation function; and c.

$$sign ( re ( c ( τ ) ) ) \vert \frac{c ( τ )}{c ( 0 )} \vert ,$$

e.g., the sign of the real part of the autocorrelation times the absolute value of the normalized autocorrelation function.

Embodiment 59: The method of any of the previous embodiments, further comprising: obtaining user data; and forwarding the user data to a host or a user equipment.

### Group C Embodiments

Embodiment 60: A user equipment or Time Domain Channel Properties, TDCP, reporting based on measurement on Tracking Reference Signal, TRS, samples, comprising: processing circuitry configured to perform any of the steps of any of the Group A embodiments; and power supply circuitry configured to supply power to the processing circuitry.

Embodiment 61: A network node for receiving Time Domain Channel Properties, TDCP, reporting based on measurement on Tracking Reference Signal, TRS, samples, the network node comprising: processing circuitry configured to perform any of the steps of any of the Group B embodiments; and power supply circuitry configured to supply power to the processing circuitry.

Embodiment 62: A user equipment (UE) or Time Domain Channel Properties, TDCP, reporting based on measurement on Tracking Reference Signal, TRS, samples, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 63: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 64: The host of the previous embodiment, wherein the cellular network further includes a network node configured to communicate with the UE to transmit the user data to the UE from the host.

Embodiment 65: The host of the previous 2 embodiments, wherein: the processing circuitry of the host is configured to execute a host application, thereby providing the user data; and the host application is configured to interact with a client application executing on the UE, the client application being associated with the host application.

Embodiment 66: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 67: The method of the previous embodiment, further comprising: at the host, executing a host application associated with a client application executing on the UE to receive the user data from the UE.

Embodiment 68: The method of the previous embodiment, further comprising: at the host, transmitting input data to the client application executing on the UE, the input data being provided by executing the host application, wherein the user data is provided by the client application in response to the input data from the host application.

Embodiment 69: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 70: The host of the previous embodiment, wherein the cellular network further includes a network node configured to communicate with the UE to transmit the user data from the UE to the host.

Embodiment 71: The host of the previous 2 embodiments, wherein: the processing circuitry of the host is configured to execute a host application, thereby providing the user data; and the host application is configured to interact with a client application executing on the UE, the client application being associated with the host application.

Embodiment 72: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 73: The method of the previous embodiment, further comprising: at the host, executing a host application associated with a client application executing on the UE to receive the user data from the UE.

Embodiment 74: The method of the previous embodiment, further comprising: at the host, transmitting input data to the client application executing on the UE, the input data being provided by executing the host application, wherein the user data is provided by the client application in response to the input data from the host application.

Embodiment 75: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 76: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 77: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 78: The method of the previous embodiment, further comprising, at the network node, transmitting the user data provided by the host for the UE.

Embodiment 79: The method of any of the previous 2 embodiments, wherein the user data is provided at the host by executing a host application that interacts with a client application executing on the UE, the client application being associated with the host application.

Embodiment 80: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 81: The communication system of the previous embodiment, further comprising: the network node; and/or the user equipment.

Embodiment 82: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 83: The host of the previous 2 embodiments, wherein: the processing circuitry of the host is configured to execute a host application, thereby providing the user data; and the host application is configured to interact with a client application executing on the UE, the client application being associated with the host application.

Embodiment 84: The host of the any of the previous 2 embodiments, wherein the initiating receipt of the user data comprises requesting the user data.

Embodiment 85: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 86: The method of the previous embodiment, further comprising at the network node, transmitting the received user data to the host.

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 3GPP | Third Generation Partnership Project |
| 5G | Fifth Generation |
| 5GC | Fifth Generation Core |
| 5GS | Fifth Generation System |
| AF | Application Function |
| AMF | Access and Mobility Function |
| AN | Access Network |
| AP | Access Point |
| ASIC | Application Specific Integrated Circuit |
| AUSF | Authentication Server Function |
| CPU | Channel State Information Processing Units |
| DCI | Downlink Control Information |
| DN | Data Network |
| DRX | Discontinuous Reception |
| DSP | Digital Signal Processor |
| eNB | Enhanced or Evolved Node B |
| EPS | Evolved Packet System |
| E-UTRA | Evolved Universal Terrestrial Radio Access |
| FPGA | Field Programmable Gate Array |
| gNB | New Radio Base Station |
| gNB-DU | New Radio Base Station Distributed Unit |
| HSS | Home Subscriber Server |
| IoT | Internet of Things |
| IP | Internet Protocol |
| LTE | Long Term Evolution |
| MME | Mobility Management Entity |
| MTC | Machine Type Communication |
| NEF | Network Exposure Function |
| NF | Network Function |
| NR | New Radio |
| NRF | Network Function Repository Function |
| NSSF | Network Slice Selection Function |
| OFDM | Orthogonal Frequency Division Multiplexing |
| OTT | Over-the-Top |
| PC | Personal Computer |
| PCF | Policy Control Function |
| P-GW | Packet Data Network Gateway |
| QoS | Quality of Service |
| RAM | Random Access Memory |
| RAN | Radio Access Network |
| ROM | Read Only Memory |
| RRC | Radio Resource Control |
| RRH | Remote Radio Head |
| RTT | Round Trip Time |
| SCEF | Service Capability Exposure Function |
| SMF | Session Management Function |
| TDCP | Time Domain Channel Property |
| TRS | Tracking Reference Signal |
| TRS-MTC | TRS Measurement Time Configuration |
| UDM | Unified Data Management |
| UE | User Equipment |
| UPF | User Plane Function |

Those skilled in the art will recognize improvements and modifications to the embodiments of the present disclosure. All such improvements and modifications are considered within the scope of the concepts disclosed herein.

1. A method performed by a User Equipment (UE) for Time Domain Channel Properties (TDCP) reporting based on measurement on Tracking Reference Signal (TRS) samples, the method comprising:
receiving from a network a reporting configuration containing a TDCP reporting quantity to be reported by the UE for TDCP reporting;
receiving from the network a reference signal configuration indicating information on one or more TRS samples;
receiving signaling from the network where the signaling comprises:
indicating one or more measurement windows; and
restricting the number of TRS samples to be considered when computing/updating TDCP reporting quantity;
computing and/or updating the TDCP reporting quantity to be reported only using one or more of:
the TRS samples in the indicated one or more measurement windows; and
indicated number of TRS samples;
receiving a Downlink Control Information (DCI) from the network triggering an aperiodic TDCP report; and
reporting the computed/updated TDCP reporting quantity.

2. The method of claim 1, wherein: the TDCP reporting quantity comprises different type of autocorrelation-based reporting quantities.

3. The method of claim 1, wherein N₁ is equal to one of: 3; 1; indicated by a UE capability; and indicated by a network configuration parameter.

4. The method claim 1, wherein the network configuration of N₁ is indicated by a parameter called timeRestrcitionForTDCPMeasurements in a Radio Resource Control (RRC) message.

5. The method of claim 1, wherein if the timeRestrictionForTDCPMeasurements is configured, N₁ is considered as 1.

6. The method of claim 1, wherein N₁ is configured by the RRC message.

7. (canceled)

8. The method of claim 1, further including: determining to discard some of the measurements or measurement opportunities within the measurement window.

9. The method of claim 1, further including: determining a number of Channel State Information Processing Units (CPUs) occupied for measurements and computation related to TDCP reporting.

10-13. (canceled)

14. The method of claim 1, wherein the length of the TRS measurement window and/or the size of the time lags for which autocorrelation can be computed within the TRS measurement window is part of UE capability.

15-18. (canceled)

19. The method of claim 1, wherein the CPU occupation duration for TDCP report is determined with respect to the TRS measurement window.

20-22. (canceled)

23. The method of claim 1, wherein if there is no available CPU for an TRS measurement window, the TDCP reporting quantities are not required to be computed/updated.

24. The method of claim 1, wherein if UE is configured with Discontinuous Reception (DRX) and if the active measurement window for TDCP report is outside of DRX active time, TDCP quantiles are not required to be updated.

25-29. (canceled)

30. The method of claim 1, wherein the UE reports measurements of one or more of the following quantities:
$$\frac{c ( τ )}{c ( 0 )} ,$$
e.g., the normalized autocorrelation function;
$$\vert \frac{c ( τ )}{c ( 0 )} \vert ,$$
e.g., the absolute value of the normalized autocorrelation function; and
$$sign ( re ( c ( τ ) ) ) \vert \frac{c ( τ )}{c ( 0 )} \vert ,$$
that is, the sign of the real part of the autocorrelation times the absolute value of the normalized autocorrelation function.

31. The method of claim 1, wherein the UE operates in a Fifth Generation (5G) system.

32. A method performed by a network node for receiving Time Domain Channel Properties (TDCP) reporting based on measurement on Tracking Reference Signal (TRS) samples, the method comprising:
transmitting to a User Equipment (UE) a reporting configuration containing a TDCP reporting quantity to be reported by the UE for TDCP reporting;
transmitting to the UE a reference signal configuration indicating information on one or more TRS samples;
transmitting signaling to the UE where the signaling comprises:
indicating one or more measurement windows; and
restricting the number of TRS samples to be considered when computing/updating TDCP reporting quantity;
transmitting Downlink Control Information (DCI) to the UE triggering an aperiodic TDCP report; and
receiving the computed/updated TDCP reporting quantity.

33. The method of claim 32, wherein: the TDCP reporting quantity comprises different type of autocorrelation-based reporting quantities.

34. The method of claim 32, wherein N₁ is equal to one of: 3; 1; indicated by a UE capability; and indicated by a network configuration parameter.

35. The method of claim 32, wherein the network configuration of N₁ is indicated by a parameter called timeRestrcitionForTDCPMeasurements in a Radio Resource Control (RRC) message.

36. The method of claim 32, wherein if the timeRestrcitionForTDCPMeasurements is configured, N₁ is considered as 1.

37. The method of claim 32, wherein N₁ is configured by the RRC message.

38-42. (canceled)

43. The method of claim 32, wherein the length of the TRS measurement window and/or the size of the time lags for which autocorrelation can be computed within the TRS measurement window is part of UE capability.

44-47. (canceled)

48. The method of claim 32, wherein the CPU occupation duration for TDCP report is determined with respect to the TRS measurement window.

49-51. (canceled)

52. The method of claim 32, wherein if there is no available CPU for an TRS measurement window, the TDCP reporting quantities are not required to be computed/updated.

53. The method of claim 32, wherein if the UE is configured with Disconinuous Reception (DRX), and if the active measurement window for TDCP report is outside of DRX active time, TDCP quantiles are not required to be updated.

54-57. (canceled)

58. The method of claim 32, wherein the UE reports measurements of one or more of the following quantities:
$$\frac{c ( τ )}{c ( 0 )} ,$$
e.g., the normalized autocorrelation function;
$$\vert \frac{c ( τ )}{c ( 0 )} \vert ,$$
e.g., the absolute value of the normalized autocorrelation function; and
$$sign ( re ( c ( τ ) ) ) \vert \frac{c ( τ )}{c ( 0 )} \vert ,$$
that is, the sign of the real part of the autocorrelation times the absolute value of the normalized autocorrelation function.

59. A User Equipment (UE) for Time Domain Channel Properties (TDCP) reporting based on measurement on Tracking Reference Signal (TRS) samples, the UE comprising processing circuitry and memory, the memory comprising instructions to cause the UE to:
receive from a network a reporting configuration containing a TDCP reporting quantity to be reported by the UE for TDCP reporting;
receive from the network a reference signal configuration indicating information on one or more TRS samples;
receive signaling from the network where the signaling comprises:
indicating one or more measurement windows; and
restricting the number of TRS samples to be considered when computing/updating TDCP reporting quantity;
compute and/or update the TDCP reporting quantity to be reported only using one or more of:
the TRS samples in the indicated one or more measurement windows; and
indicated number of TRS samples;
receive a DCI from the network triggering an aperiodic TDCP report; and
report the computed/updated TDCP reporting quantity.

60-64. (canceled)
